(19) United States
(12) Patent Application Publication
(10) Pub. No.: US 2008/0218443 A1
(43) Pub. Date: Sep. 11, 2008

(54) METHOD FOR DRIVING A PLASMA DISPLAY PANEL

(75) Inventors: Yuichi SAKAI, Chuo-shi (JP); Hajime HOMMA, Chuo-shi (JP); Ayuhiko SAITO, Chuo-shi (JP); Takashi MASHITA, Chuo-shi (JP); Koji HASHIMOTO, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 12/043,712

(22) Filed: Mar. 6, 2008

(30) Foreign Application Priority Data
Mar. 7, 2007 (JP) 2007-057185
May 9, 2007 (JP) 2007-124630

(51) Int. Cl. G09G 3/28

(52) U.S. Cl. 345/60

(57) ABSTRACT

A driving method in which, when a sustain discharge is caused only at each discharge cell set in on-mode by applying a sustain pulse to each row electrode pair of a plasma display panel, the electric field between row electrodes of each row electrode pair can be intensified by applying an auxiliary pulse to each column electrode of the plasma display panel together with the sustain pulse.

### BACKGROUND OF THE INVENTION

1. Field of the Invention

The present invention relates to a method for driving a plasma display panel.

2. Description of the Related Background Art

Plasma display panels of AC type (alternating-current discharge type) have recently been put into production as thin-model displays. A plasma display panel contains two substrates, i.e., a front glass substrate and a rear glass substrate which are opposed to each other with a predetermined gap therebetween. A plurality of pairs of row electrodes which are paired with each other and extended in parallel are formed on the inner surface (the side opposed to the rear glass substrate) of the foregoing front glass substrate, or a display surface, as pairs of sustain electrodes. A plurality of column electrodes are formed on the rear glass substrate as address electrodes so as to extend orthogonal to the pairs of row electrodes, and phosphors are further applied thereto. When viewed from the foregoing display-surface side, display cells corresponding to pixels are formed at intersections of the pairs of row electrodes and the column electrodes.

The plasma display panel is subjected to gradation driving based on a sub-field method for the sake of achieving halftone display luminance corresponding to an input video signal.

In the gradation driving based on the sub-field method, a display drive for a single field of a video signal is performed in a plurality of individual sub-fields to which respective intended numbers of times (or periods) of light emission are assigned. In each sub-field, an address stage and a sustain stage are performed in succession. At the address stage, selective discharge is generated between the row electrodes and the column electrodes of respective display cells selectively in accordance with the input video signal, thereby forming (or erasing) a predetermined amount of wall charge. At the sustain stage, sustain pulses are applied to each row electrode so that display cells having the predetermined amount of wall charge formed therein alone generate discharge repeatedly to sustain the light-emitting state resulting from the discharge. An initialization stage is also performed at least in the first sub-field, prior to the address stage. In the initialization stage, reset discharge is generated between the paired row electrodes in all the display cells, thereby initializing the amount of wall charge remaining in each display cell.

The sustain discharge occurs simultaneously in a number of discharge cells in the sustain stage, a great amount of current flows instantaneously to cause a distortion in the voltage waveform of the sustain pulse. As a result, a difference occurs in value of the application voltage for causing a discharge depending upon whether the discharge cells to cause a sustain discharge in one screen are greater or smaller in the number, thus raising variations in discharge intensity. In such a case, brightness irregularity is possibly encountered due to the variations of discharge intensity.

In this situation, a proposal has been made on a drive method that, in the sustain stage, the sustain pulse to apply the second is established longer in rise time than the sustain pulse to apply in the later (see Japanese Patent Laid-Open No. 2006-330603, for example). In this driving method, a first round of discharge is caused by a sustain pulse applied the second in a rise period thereof, followed by an occurrence of a second round of discharge in a pulse peak period. By the twice, successive discharges (hereinafter referred to as twice discharges), the discharge light intensity to be visually perceived is given nearly equal between the cases the discharge cells to cause discharge simultaneously is greater and smaller in the number, thus improving the brightness irregularity.

However, where displaying an image of low luminance, the discharge tends to delay because of the reduction in the number of times of sustain discharges to cause within each sub-field and hence in the amount of charged grains remaining within the discharge cell. In this case, in case the sustain pulse to apply the second be increased in its rise period as in the foregoing, the first round of discharge possibly does not occur in the rise period of the pulse, thus resulting in a problem the improvement effect of brightness irregularity could not be exhibited.

Meanwhile, the plasma display panel has a discharge characteristic varying on a cell-by-cell basis with an increase of its cumulative use period. This is because of the reason that the picture in cumulative display varies on a cell-by-cell basis. The cell-based difference of discharge characteristics results in a difference in sustain-discharge start timing between cells or between cumulative use periods. Where sustain discharge varies in discharge start timing, there arise those cells that sustain discharge occurs in a rise course of the sustain pulse and those cells that sustain discharge occurs after reached the peak potential (rated potential). Even in the rise process, there arise cells where the occurrences of sustain discharges are different in timing.

Here, the row electrode pair has an electrode-to-electrode voltage varying in timing between during a rise process and after reached the rated potential, and further in each of timing during the rise process. The electrode-to-electrode voltage of the row electrode pair, if varies during a sustain discharge, gives rise to variations in the light-emission intensity of the sustain discharge occurring at that time.

Namely, in a structure that sustain discharge occurs in a rise process, sustain discharge has a light-emission intensity varying between discharge cells or between cumulative use periods if discharge characteristics vary on a cell-by-cell basis with an increase of cumulative use period.

### SUMMARY OF THE INVENTION

Therefore, it is an object of the present invention to provide a plasma display panel driving method capable of displaying an image well by suppressing the light-emission intensity of sustain discharge from varying even where discharge characteristics are changed between discharge cells with the increase of cumulative use time.

A plasma display panel driving method in the invention is a method for driving a plasma display panel based on gradation levels of a plurality of sub-fields for each unit display period of an input video signal, wherein the plasma display panel has front and back substrates oppositely arranged sandwiching a discharge space filled with discharge gas, a plurality of pairs of row electrodes arranged between the front substrate and the back substrate, and a plurality of column electrodes arranged intersecting with the row electrode pairs, so as to respectively form discharge cells each having a phosphor layer at intersections of the row electrode pairs and the column electrodes, the method comprising: executing, in each of the sub-fields, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pair; wherein, in the sustain stage, an auxiliary pulse for maintaining a pulse peak potential is applied to the row electrodes during at least part of a leading-edge period of the sustain pulse.

When causing sustain discharges only in the discharge cells staying in the on-mode by applying a sustain pulse to the row electrodes of the plasma display panel, an auxiliary pulse is applied, together with the sustain pulse, to the row electrodes of the plasma display panel, thereby increasing the electric-field intensity between the row electrodes. This makes it possible to positively cause a sustain discharge even where a sustain pulse increased in the leading edge period of the pulse in order to eliminate brightness irregularity in the state the charged grains remaining in the discharge cell are less in amount than the amount required to cause a discharge. Therefore, image display is available well with brightness irregularity suppressed even when making a display low in light intensity that the charged grains remaining in the discharge cell are deficient in amount because sustain discharges to execute are smaller in the number of times.

Meanwhile, power consumption is to be reduced by applying the auxiliary pulse only in the beginning of each sustain stage or in the sustain stage of a sub-field immediately succeeding the sub-field whose intensity weight is smaller than a predetermined value

A plasma display panel driving method in the invention is a method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising: executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs; wherein, in the sustain stage, the other row electrodes are placed in a floating state during at least part of a period from a time point of a leading edge before reaching a peak potential of the sustain pulse, on the one row electrodes, to a time point reaching the peak potential, and then set equal to a ground potential following the floating state.

In the plasma display panel driving method of the invention, each of the other row electrodes in the sustain light-emission stage is placed in a floating state in the sustain emission stage, during at least part of a period from a time of the leading edge of before reaching a peak potential of the sustain pulse to each one row electrode of a plurality of row electrode pairs to a time of reaching the peak potential, followed by being made equal to the ground potential. Accordingly, in the floating state at the leading edge of the sustain pulse, sustain discharge is prevented because the voltage between the row electrodes does not reach a discharge start voltage. When the sustain pulse is at a peak potential, the floating state is canceled to cause a sustain discharge in each cell due to the application of the ground potential. In the discharge cells, because the voltages applied to between the row electrodes are nearly equal during the sustain discharge, sustain discharges are nearly equal in discharge intensity thus providing sustain discharges with light-emission intensities nearly equal. Therefore, image display is available well with brightness irregularity suppressed from varying even when discharge characteristics vary between the discharge cells with the increase of cumulative use time.

A plasma display panel driving method in the invention is a method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising: executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs; wherein, in the sustain stage, each of the other row electrodes is set equal to a ground potential through an element having an impedance of a predetermined value or greater during at least part of a period from a time point of a leading edge before reaching a peak potential of the sustain pulse, on the one row electrodes, to a time point reaching the peak potential, and then directly set equal to the ground potential.

In the plasma display panel driving method of the invention, each of the other row electrodes in the sustain light-emission stage is placed equal to a ground potential through an element with an impedance having a predetermined value or greater, during at least part of a period from a time of the leading edge of before reaching a peak potential of the sustain pulse to each one row electrode of a plurality of row electrode pairs to a time of reaching the peak potential, followed by being directly made equal to the ground potential. Accordingly, in the state an element having an impedance is connected to the other row electrode at a time of leading edge of the sustain pulse, the voltage between the row electrodes does not reach a discharge start voltage thus preventing a sustain discharge. When a ground potential is applied directly to the other row electrode at a peak potential of the sustain pulse, sustain discharge is caused in each discharge cell. In the discharge cells, because the voltages applied to between the row electrodes are nearly equal during the sustain discharge, sustain discharges are nearly equal in discharge intensity thus providing sustain discharges with light-emission intensities nearly equal. Therefore, image display is available well with brightness irregularity suppressed from varying even when discharge characteristics vary between the discharge cells with the increase of cumulative use time.

A plasma display panel driving method in the invention is a method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising: executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs; wherein, in the sustain stage, each of the other row electrodes is applied with a positive or negative potential during at least part of a period from a time point of a leading edge before reaching a peak potential of the sustain pulse, on the one row electrodes, to a time point reaching the peak potential, and then directly set equal to the ground potential.

In the plasma display panel driving method of the invention, each of the other row electrodes in the sustain light-emission stage is applied with a positive or negative potential, during at least part of a period from a time of the leading edge of before reaching a peak potential of the sustain pulse to each one row electrode of a plurality of row electrode pairs to a time of reaching the peak potential, followed by being made equal to the ground potential. Accordingly, the other row electrode is at a positive or negative potential at a time of the leading edge of the sustain pulse, sustain discharge is prevented because the voltage between the row electrodes does not reach a discharge start voltage. When the sustain pulse is at a peak potential due to the cancellation from the application of the positive or negative potential, if-a ground potential is applied, sustain discharge is caused in each discharge cell. In the discharge cells, because the voltages applied to between the row electrodes are nearly equal during the sustain discharge, sustain discharges are nearly equal in discharge intensity thus providing sustain discharges with light-emission intensities nearly equal. Therefore, image display is available well with brightness irregularity suppressed from varying even when discharge characteristics vary between the discharge cells with the increase of cumulative use time.

### BRIEF DESCRIPTION OF THE DRAWINGS

FIG. 1 is a diagram showing a schematic structure of a plasma display apparatus to which a driving method according to the present invention is applied;

FIG. 2 is a front view schematically showing an internal structure of a PDP in the FIG. 1 apparatus;

FIG. 3 is a view showing a section taken on line V-V shown in FIG. 2;

FIG. 4 is a view showing a section taken on line W-W shown in FIG. 2;

FIG. 5 is a view schematically showing an MgO crystal contained in a phosphor layer in a pixel cell of the FIG. 2 PDP;

FIG. 6 is a figure showing a light-emission pattern on a level-by-level basis;

FIG. 7 is a figure showing an example of a light-emission drive sequence where a selective erase address scheme is applied as a light-emission drive scheme to the FIG. 1 apparatus;

FIG. 8 is a figure showing a waveform of a drive pulse to be applied to the PDP according to a FIG. 7 drive sequence;

FIG. 9 is a figure showing an intensity change of a cathode-at-column discharge caused upon applying a reset pulse to the existing PDP.

FIG. 10 is a figure showing an intensity change of a cathode-at-column discharge caused upon applying a reset pulse to the PDP having a FIG. 5 structure;

FIG. 11 is a figure showing the application timing of the auxiliary pulse relative to the sustain pulse and the occurrence timing of discharge;

FIG. 12 is a figure showing another waveform of the reset pulse;

FIG. 13 is a figure showing a waveform of another drive pulse to be applied to the PDP according to the FIG. 7 drive sequence;

FIG. 14 is a circuit diagram showing a configuration of respective sustain-pulse generating circuits for X-electrode and Y-electrode drivers in the FIG. 1 apparatus;

FIG. 15 is a figure showing an operation in generating a sustain pulse to be applied to the row electrode Xj, in the FIG. 14 circuit;

FIG. 16 is a figure showing an operation in generating a sustain pulse to be applied to the row electrode Yj, in the FIG. 14 circuit;

FIGS. 17A and 17B are figures each showing a potential on the row electrode and a discharge intensity, respectively at a cell earlier in discharge start timing and a cell later in discharge start timing;

FIG. 18 is a view schematically showing a form where a phosphor layer is constructed by laying a secondary electron emission layer on the surface of a phosphor particle layer;

FIG. 19 is a figure showing another example of a light-emission drive sequence where a selective write address scheme is employed as a light-emission drive scheme in the FIG. 1 apparatus;

FIG. 20 is a figure showing an intensity-level-based light-emission pattern of the FIG. 19 light-emission drive sequence;

FIG. 21 is a figure showing a waveform of a drive pulse to be applied to the PDP according to the FIG. 19 light-emission drive sequence;

FIG. 22 is a figure showing a waveform of another drive pulse to be applied to the PDP according to the FIG. 19 light-emission drive sequence;

FIG. 23 is a figure showing a waveform of a drive pulse to be applied to the PDP according to the FIG. 19 light-emission drive sequence; and

FIG. 24 is a figure showing a waveform of a drive pulse to be applied to the PDP according to the FIG. 19 light-emission drive sequence.

### DETAILED DESCRIPTION OF THE INVENTION

With referring to the drawings, explanation will be now made on embodiments according to the present invention.

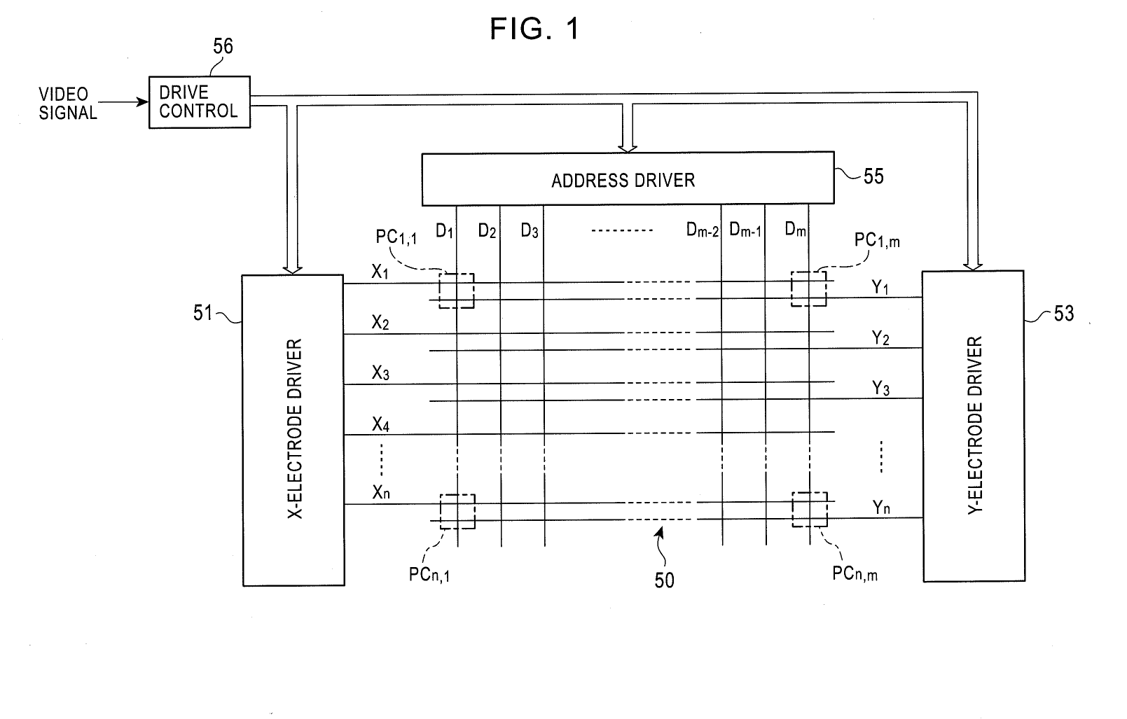

FIG. 1 is a diagram showing a schematic configuration of a plasma display apparatus whose plasma display panel is driven using a drive scheme according to the present invention.

The plasma display apparatus comprises a plasma display panel or PDP 50, an X-electrode driver 51, a Y-electrode driver 53, an addressing driver 55 and a drive control circuit 56, as shown in FIG. 1.

In the PDP 50, column electrodes D₁ to Dₘ are extended and arranged in the longitudinal direction (vertical direction) of a two-dimensional display screen, and row electrodes X₁ to Xₙ and row electrodes Y₁ to Yₙ are extended and arranged in the lateral direction (the horizontal direction) thereof. The row electrodes X₁ to Xₙ and row electrodes Y₁ to Yₙ form row electrodes pairs (Y₁, X₁), (Y₂, X₂), (Y₃, X₃), . . . , (Yₙ, Xₙ) which are paired with those adjacent to each other and which serve as the first display line to the nth display line in the PDP 50. In each intersection part of the display lines with the column electrodes D₁ to Dₘ (areas surrounded by dashed lies in FIG. 1), a display cell PC which serves as a pixel is formed. More specifically, in the PDP 50, the display cells PC_{1,1} to PC_{1,m} belonging to the first display line, the display cells PC_{2,1} to PC_{2,m} belonging to the second display line, and the display cells PC_{n,1} to PC_{n,m} belonging to the nth display line are each arranged in a matrix.

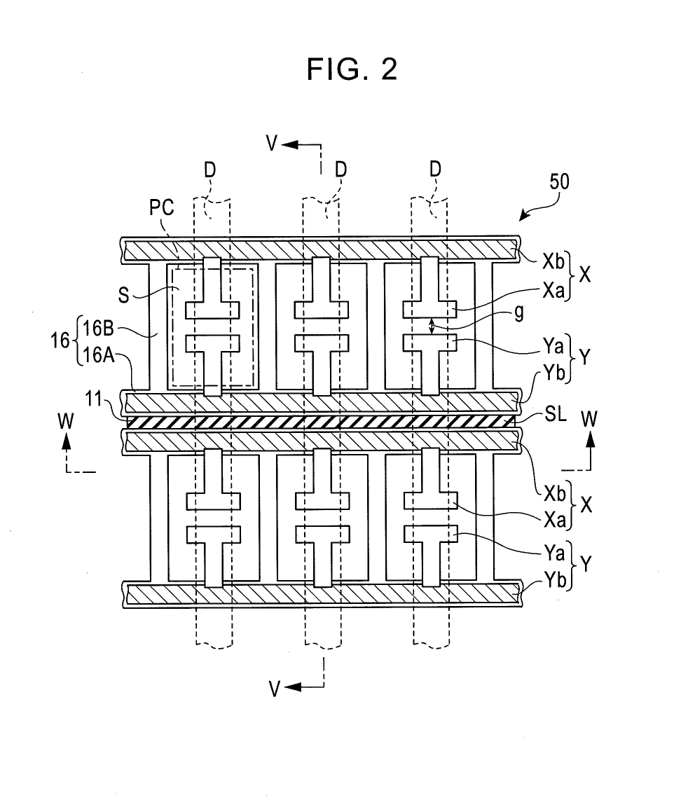

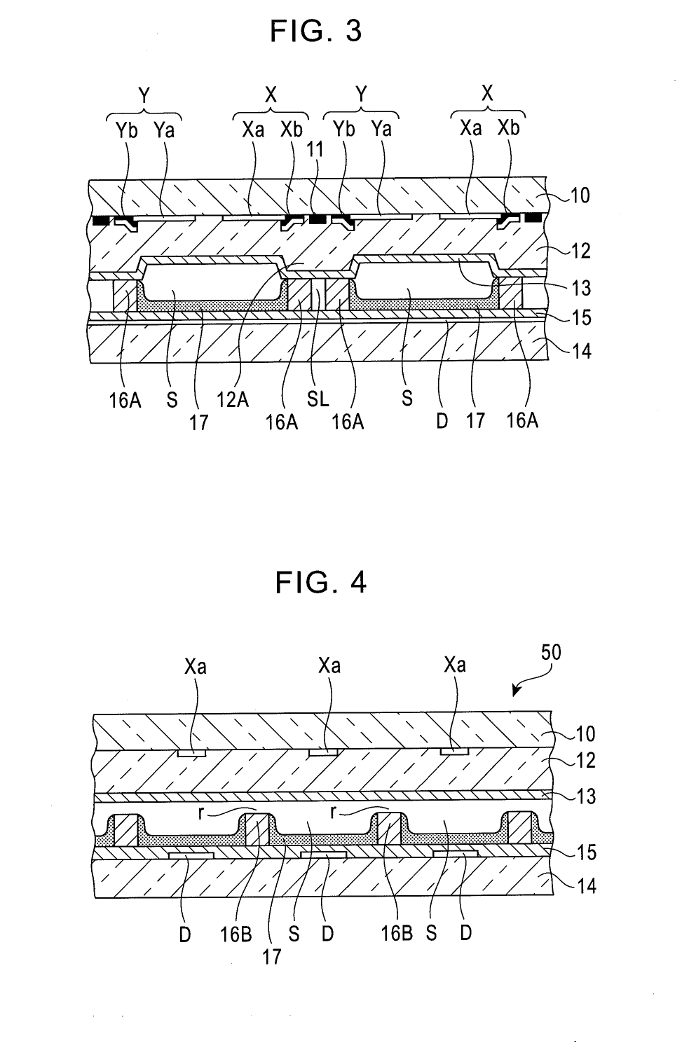

FIG. 2 is a front view typically showing the internal structure of the PDP 50 as viewed at from the screen. Note that FIG. 2 illustrates representatively the intersections of three column electrodes D that are adjacent mutually and two display lines that are adjacent mutually. FIG. 3 depicts a diagram illustrating a cross section of the PDP 50 at a line V-V in FIG. 2, and FIG. 4 depicts a diagram illustrating a cross section of the PDP 50 at a line W-W in FIG. 2.

As shown in FIG. 2, each row electrodes X has a bus electrode Xb extending horizontally of the two-dimensional display screen and a T-form transparent electrode Xa provided at a position contacting with the bus electrode Xb and corresponding to the display cell PC. Each row electrode Y is structured with a bus electrode Yb extending horizontally of the two-dimensional display screen and a T-form transparent electrode Ya provided at a position contacting with the bus electrode Yb and corresponding to the display cell PC. The transparent electrodes Xa, Ya are each formed by a transparent conductive film such as ITO while the bus electrodes Xb, Yb are each formed by a metal film, for example. The row electrodes X, each formed by the transparent electrode Xa and the bus electrode Xb, and the row electrodes Y, each formed by the transparent electrode Ya and the bus electrode Yb, are formed on a back surface of the front transparent substrate 10 providing a display surface of the PDP 50, as shown in FIG. 3. In this case, the transparent electrodes Xa and Ya in each row electrode pair (X, Y) are extended to the counterpart row electrode side to be paired, and have wide portions. The wide portions have respective tip sides opposed to each other through a discharge gap g1 having a predetermined width. On the backside of the front transparent substrate 10, a light absorbing layer (shade layer) 11 having black or dark color is formed extending horizontally of the two-dimensional display screen, between the adjacent ones of the row electrode pairs (X, Y). Furthermore, on the backside of the front transparent substrate 10, a dielectric layer 12 is formed so as to cover the row electrode pairs (X, Y). The dielectric layer 12 is formed, at its backside (in a surface opposite to the surface contacted with the row electrode pairs), with an increased dielectric layer portion 12A at a position corresponding to a region formed with the light absorbing layer 11 and the bus electrodes Xb, Yb adjacent to the light absorbing layer 11, as shown in FIG. 3.

A magnesium oxide layer 13 is formed on a surface of the dielectric layer 12 including the layer portion 12A. The magnesium oxide layer 13 contains a magnesium oxide crystal (hereinafter, referred to as CL-emission MgO crystallization) serving as a secondary-electron emission material to cause CL (cathode luminescence) emission having a peak at a wavelength of 200-300 nm, particularly 230-250 nm, when excited with the illumination of an electronic ray. The CL-emission MgO crystallization is obtainable by the vapor phase oxidation of a magnesium vapor produced by heating magnesium, which has a polycrystal structure that cubic crystals are compacted together or a cubic single-crystal structure, for example. The CL-emission MgO crystallization has a mean grain size of 2000 angstroms or greater (measurement result by the BET method).

In order to form a magnesium-oxide single crystal having the mean grain size as great as 2000 angstroms or greater by a vapor phase process, there is a need to increase the heating temperature for producing a magnesium vapor. This increases the flame length for causing magnesium and oxide to react. As the vapor-phase-oxidized magnesium single crystal increases in grain size with the increasing temperature difference between the flame and the surrounding, those can be formed greater in the number having an energy level corresponding to the peak wavelength (e.g. around 235 nm, within 230-250 nm) of CL emission as mentioned above.

The energy level corresponding to the CL-emission peak wavelength is provided for the vapor-phase-oxidized magnesium single crystal produced by reacting the greater quantity of oxygen through increasing the amount of magnesium to vaporize per unit time and increasing the reaction area of magnesium with oxygen, as compared to the usual vapor-phase oxidation.

By attaching the CL-emission MgO crystallization to the surface of the dielectric layer 12 by spraying, electrostatic application or so, the magnesium oxide layer 13 is formed. Alternatively, by forming a thin-film magnesium oxide layer on the surface of the dielectric layer 12 by evaporation or sputtering, CL-emission MgO crystallization may be attached thereto thereby forming the magnesium oxide layer 13.

On a back substrate 14 arranged parallel with the front transparent substrate 10, column electrodes D are formed extending orthogonally to the row electrode pairs (X, Y), in a position opposed to the transparent electrodes Xa, Ya of the row electrode pair (X, Y). Over the back substrate 14, a column-electrode protection layer 15 white in color is further formed covering the column electrodes D. Barriers 16 are formed on the column-electrode protection layer 15. The barrier 16 is formed in a ladder form with a transverse wall 16A extending transversely of the two-dimensional display screen and a longitudinal wall 16B extending lengthwise of the two-dimensional display screen intermediately between the adjacent column electrodes D, in a position corresponding to the bus electrodes Xb, Yb of the row electrode pair (X, Y). Furthermore, the ladder-formed barrier 16 as shown in FIG. 2 is formed on each of display lines of the PDP 50. Gaps SL exist between adjacent ones of the barriers 16, as shown in FIG. 2. By the ladder-like barrier 16, display cells PC each including a discharge space S and transparent electrodes Xa, Ya are zoned. The discharge space S fills therein a discharge gas containing a xenon gas. In the display cell PC, a phosphor layer 17 is formed over the side surface of the transverse wall 16A, the side surface of the longitudinal wall 16B and the surface of the column-electrode protection layer 15, in a manner covering the entire of those surfaces. The phosphor layer 17 practically includes three types, i.e. a phosphor for red emission, a phosphor for green emission and a phosphor for blue emission.

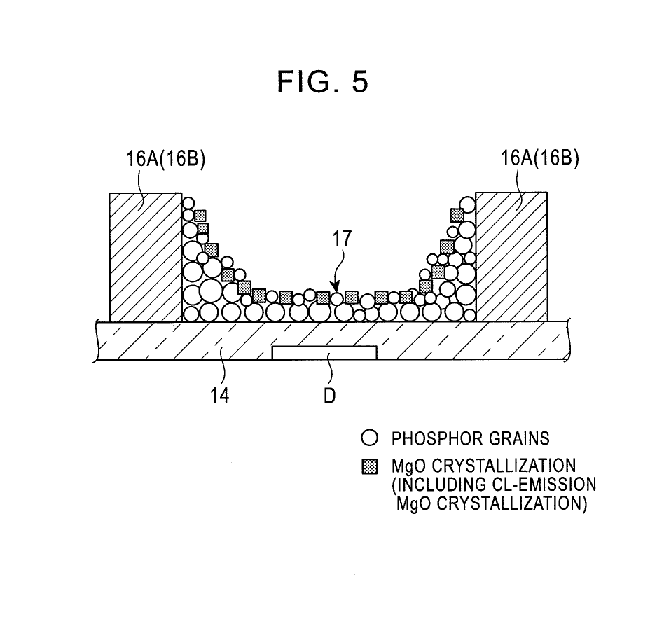

Incidentally, the phosphor layer 17 contains an MgO crystallization (including a CL-emission MgO crystallization) as a secondary-electron emission material, in a form as shown in FIG. 5 for example. In this case, the MgO crystallization is exposed from the phosphor layer 17 in a manner contacting with a discharge gas, at least in the surface of the phosphor layer 17, i.e. the surface contacting with the discharge space S.

Here, the discharge space S of the display cell PC and the gap SL are closed from each other by providing the magnesium oxide layer 13 in contact with the transverse wall 16A, as shown in FIG. 3. Further, because the longitudinal wall 16B is not in contact with the magnesium oxide layer 13 as shown in FIG. 4, a gap “r” exists between those. Namely, the display cells PCs, adjacent transversely of the two-dimensional display screen, have respective discharge spaces S communicating with each other through the gap “r”.

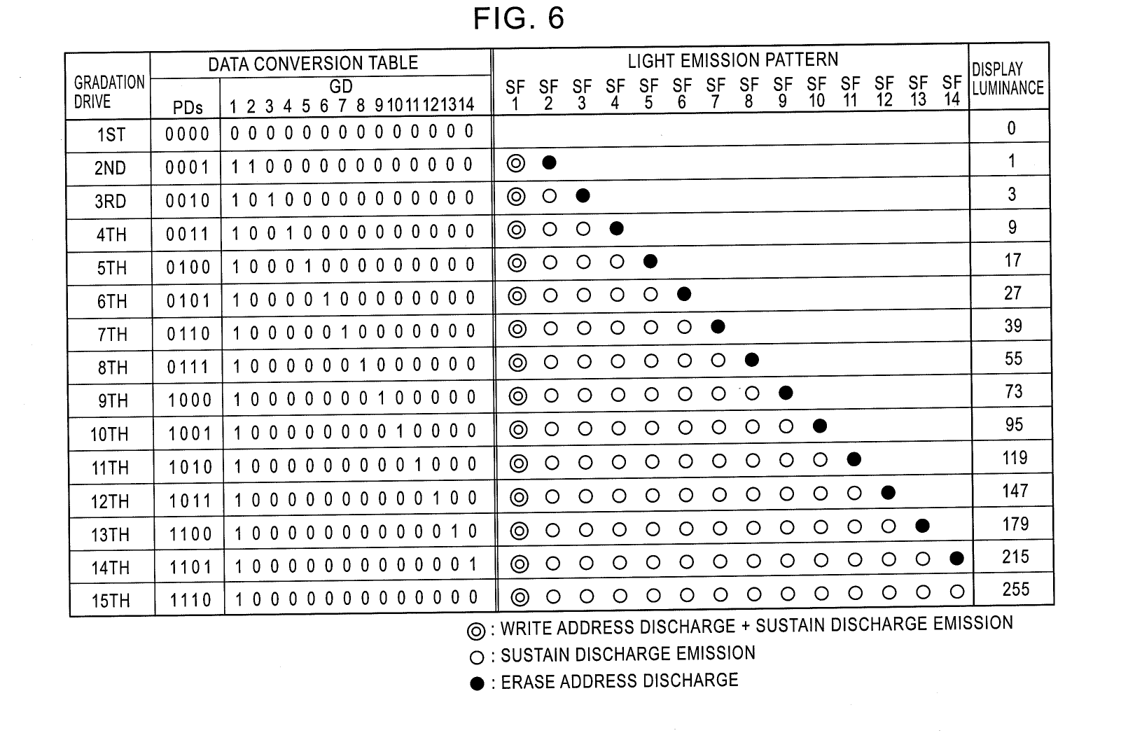

The drive control circuit 56 first converts the input video signal into 8-bit pixel data which expresses its luminance levels in 256 tone levels pixel by pixel, and performs multi-gradation processing consisting of error diffusion processing and dither processing to the pixel data. Namely, firstly, in the error diffusion processing, the high-order six bits of the pixel data are taken as display data while the remaining low-order two bits are as error data. By reflecting the display data with the weighted addition of the error data concerning the pixel data corresponding to surrounding pixels, 6-bit error-diffusion pixel data is obtained. With such error diffusion, the low-order two bits of luminance on one pixel is synthetically represented by pixels surrounding the one pixel. Therefore, gray-scale representation is available equivalently to 8-bit pixel data, by means of 6-bit display data smaller than 6-bit one. Then, the drive control circuit 56 performs dithering on the error-diffused pixel data obtained by the 6-bit error diffusion. In dithering, by taking a plurality of mutually adjacent pixels as one pixel unit, dither coefficients different one from another are assigned and added to the respective ones of error-diffused pixel data corresponding to the pixels of one pixel unit, thereby obtaining dither-added pixel data. With such addition of dither coefficients, gradation representation is available correspondingly to 8 bits by use of only the high-order four bits of the dither-added pixel data. For this reason, the drive control circuit 56 converts the high-order four bits of the dither-added pixel data into 4-bit mult-gradation pixel data PDₛ that every luminance level is to be represented with 15 levels, as shown in FIG. 6. The drive control circuit 56 converts the mult-gradation pixel data PDₛ into 14-bit pixel drive data GD according to a data conversion table as shown in FIG. 6. The drive control circuit 56 puts the first to 14-th bits of the pixel drive data GD respectively corresponding to sub-fields SF1-SF14 (referred later) and supplies the bit digits corresponding to the sub-field SF, as pixel drive data bit, in an amount of one display line (m in the number) per time to the address driver 55.

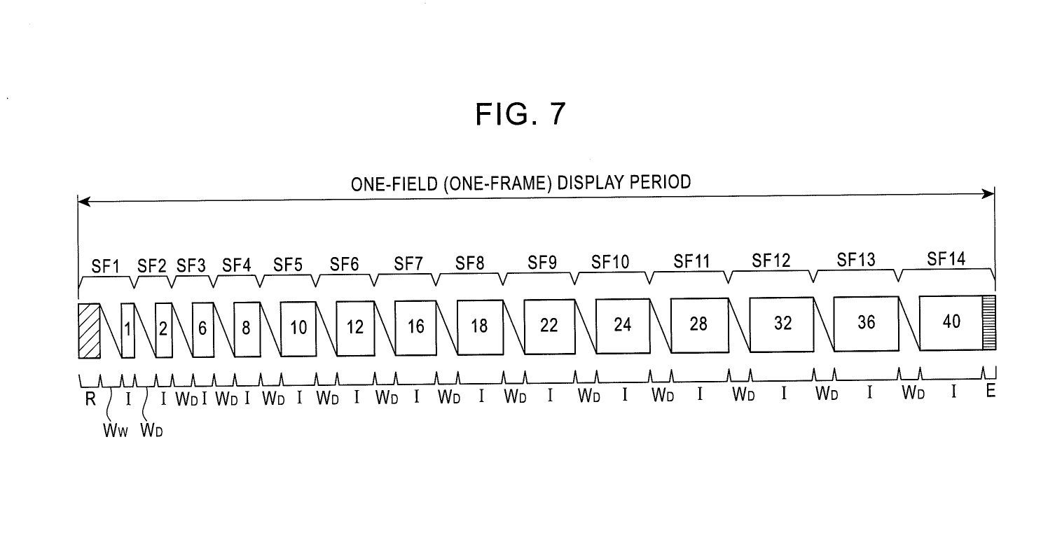

Furthermore, the drive control circuit 56 supplies the various control signals for driving the PDP 50 constructed as above in accordance with the light-emission drive sequence as shown in FIG. 7, to the panel driver formed by the X-electrode driver 51, the Y-electrode driver 53 and the address driver 55. Namely, in the beginning sub-field SF1 within a one-field (one-frame) display period as shown in FIG. 7, the drive control circuit 56 supplies the panel driver with various control signals to sequentially execute the driving according to a reset stage (first reset stage) R, a selective write address stage W_{W} and a sustain (sustained discharge) stage I. In each of sub-fields SF2-SF14, various control signals are supplied to the panel driver, to sequentially execute the driving corresponding to a selective erase address stage W_{D} and a sustain stage (sustained light-emission stage) I. In the last sub-field SF14 within the one-field (one-frame) display period, the drive control circuit 56 after executing the sustain stage I supplies the panel driver with various control signals to sequentially execute the driving corresponding to an erase stage E.

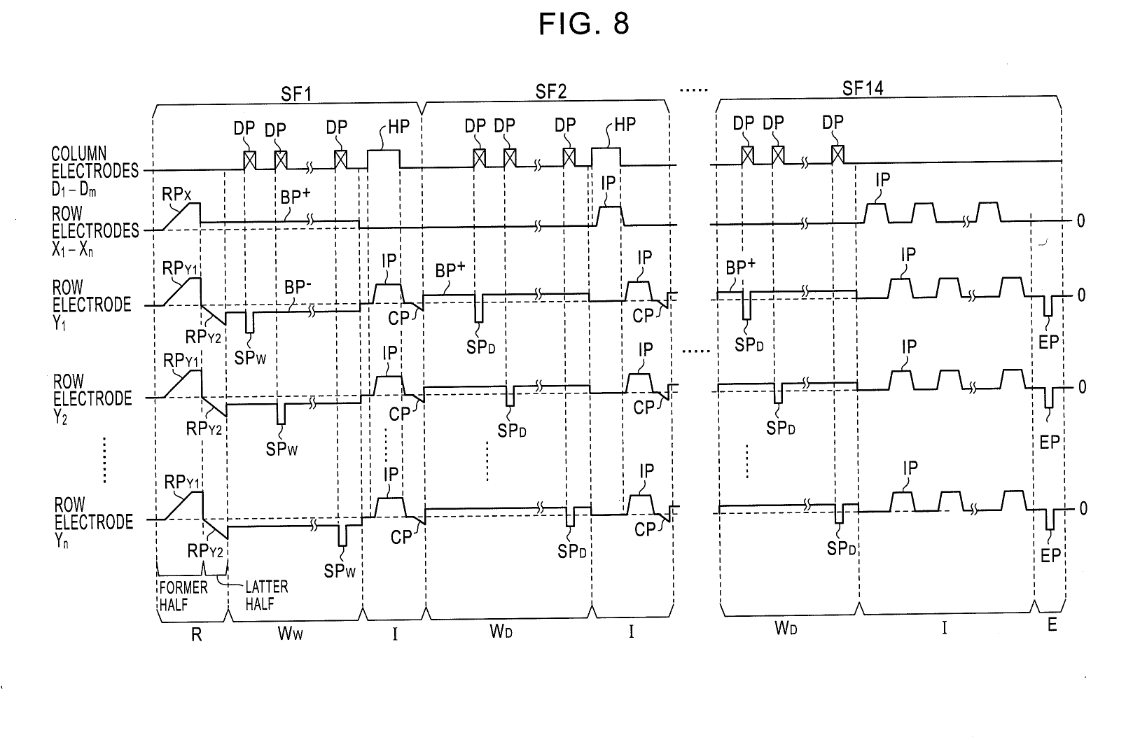

The panel driver, i.e. X-electrode driver 51, Y-electrode driver 53 and address driver 55, generates various drive pulses as shown in FIG. 8 and supplies those to the column electrode D and the row electrodes X, Y, of PDP 50 in accordance with the various control signals supplied from the drive control circuit 56.

FIG. 8 representatively shows only the operations in the beginning sub-field SF1, the subsequent sub-field SF2 and the last sub-field SF14, out of the sub-fields SF1-SF14 shown in FIG. 7.

In the outset, in the former half of the reset stage R of the sub-field SF1, the Y-electrode driver 53 applies to all the row electrodes Y₁-Yₙ a positive reset pulse RP_{Y1} having a waveform moderate in potential change at the leading edge with the passage of time as compared to the sustain pulse, referred later. Note that the reset pulse RP_{Y1} has a peak potential higher than the peak potential of the sustain pulse. In this duration, the address driver 55 sets the column electrodes D₁-Dₘ at a ground potential (0 volt). Due to the application of the reset pulse RP_{Y1}, first reset discharge is caused between the row electrode Y and the column electrode D in every discharge cell PC. Namely, in the former half of the reset stage R, voltage is applied such that the row electrode Y serves as an anode and the column electrode D as a cathode thereby causing, as a first reset discharge, a discharge that a current flows from the row electrode Y to the column electrode D (hereinafter, referred to as an cathode-at-column discharge). By the first reset discharge, wall charges are formed negative around the row electrode Y and positive around the column electrode D in every discharge cell PC.

Furthermore, in the former half of the reset stage R, the X-electrode driver 51 applies to all the row electrodes X₁-Xₙ a reset pulse RP_{X} identical in polarity to the reset pulse RP_{Y1} and having a peak potential capable of preventing against the surface discharge as caused between the row electrodes X and Y by the application of the reset pulse RP_{Y1}.

In the latter half of the rest process R of the sub-field SF1, the Y-electrode driver 53 generates a negative polarity reset pulse RP_{Y2} moderate in potential change at the leading edge with the passage of time and applies it to all the row electrodes Y₁-Yₙ. In the latter half of the reset stage R, the X-electrode driver 51 applies to the row electrodes X₁-Xₙ a base pulse BP⁺ having a peak potential positive in polarity as shown in FIG. 8. By the application of the negative reset pulse RP_{Y2} and the positive base pulse BP⁺, a second reset discharge is caused between the row electrodes X and Y in every discharge cell PC. By the second reset discharge, the greater part of the wall charges are erased that have been formed around the row electrodes X and Y in every discharge cell PC. This initializes all the discharge cells PCs into off-mode. Furthermore, by the application of the reset pulse RP_{Y2}, a weak discharge is caused also between the row electrode Y and the column electrode D in every discharge cell PC, to erase part of the positive wall charges that have been formed around the column electrode D. Due to this, the wall charges remaining around the column electrode D in every discharge cell PC are adjusted to an amount for correctly causing a selective write address discharge in a selective write address stage W_{W}, referred later.

Incidentally, the voltage, to be applied to between the row electrodes X and Y by means of the reset pulse RP_{Y2} and base pulse BP⁺, is given as a value that can positively cause a second reset discharge between the row electrodes X and Y in consideration of the wall charges formed around the row electrodes X, Y by the first reset discharge. Meanwhile, the negative peak potential of the reset pulse RP_{Y2} is set at a potential higher than the peak potential of a negative write scan pulse SP_{W} referred later, i.e. at a potential approximate to 0 volt. Namely, in case the peak potential of the reset pulse RP_{Y2} is provided lower than the peak potential of the write scan pulse SP_{W}, an intense discharge is caused between the row electrode Y and the column electrode D, thus greatly erasing the wall charges formed around the column electrode D and hence making the address discharge instable in the selective write address stage W_{W}.

In the selective write address stage W_{W} of the sub-field SF1, the Y-electrode driver 53 applies a write scan pulse SP_{W} having a negative peak potential selectively, in order, to the row electrode Y₁-Yₙ while simultaneously applying a base pulse BP⁻ having such a negative peak potential as shown in FIG. 8. In this duration, the X-electrode driver 51 continuously applies a base pulse BP⁺ having a positive peak potential to the row electrodes X₁-Xₙ. In this case, the voltage, applied to between the row electrodes X and Y by means of the base pulses BP⁺, BP⁻, is lower than a discharge start voltage for the discharge cell PC.

In the selective write address stage W_{W}, the address driver 55 first converts the pixel-drive data bit corresponding to the sub-field SF1 into a pixel data pulse DP having a pulse voltage suited for the logic level thereof. For example, when supplied a pixel-drive data bit having a logic level 1 for setting the discharge cell PC in on-mode, the address driver 55 converts it into a pixel data pulse DP having a positive peak potential. Meanwhile, it converts a pixel-drive data bit having a logic level 0 for setting the discharge cell PC in off-mode into a pixel data pulse DP low in voltage (0 volt). The address driver 55 applies the pixel data pulse DP in an amount of one display line per time (m in the number) to the column electrodes D₁-Dₘ synchronously with the application timing of each write scan pulse SP_{W}. In this case, simultaneously with the write scan pulse SP_{W}, a selective write address discharge is caused between the column electrode D and the row electrode Y in the discharge cell PC to which has been applied the pixel data pulse DP high in voltage for setting to an on-mode. Furthermore, immediately after the selective write address discharge, a weak discharge is caused also between the row electrodes X and Y in the relevant discharge cell PC. Namely, after the application of the write scan pulse SP_{W}, a voltage is applied to between the row electrodes X and Y in an amount commensurate with the base pulses BP⁻, BP⁺. However, because this voltage is set at a voltage lower than the discharge start voltage for the discharge cells PCs, no discharge is caused within the discharge cell PC only by the application of the voltage. However, once a selective write address discharge is caused, a discharge is caused between the row electrodes X and Y only with the voltage application of the base pulses BP⁻, BP⁺ due to the inducement of the selective write address discharge. By the discharge and the selective write address discharge, the discharge cell PC is formed with wall charges positive at around the row electrode Y and negatively at around the row electrode X and at around the column electrode D, i.e. set in on-mode. Meanwhile, simultaneously with the write scan pulse SP_{W}, a selective write address discharge like the above is not caused between the column electrode D and the row electrode Y in the discharge cell PC to which has been applied the pixel data pulse DP low in voltage (0 volt) for setting to off-mode. Thus, no discharge occurs between the row electrodes X and Y. Therefore, the relevant discharge cell PC remains in the state immediately before, i.e. set in off-mode initialized in the reset stage R.

In the sustain stage I of the sub-field SF1, the Y-electrode driver 53 generates a sustain pulse IP having a positive peak potential in an amount of one pulse and applies it to the row electrodes Y₁-Yₙ simultaneously. In this duration, the X-electrode driver 53 sets the row electrodes X₁-Xₙ at the ground potential (0 volt). In the sustain stage I of the sub-field SF1, the address driver 55 generates an auxiliary pulse HP having a pulse waveform that a positive peak potential is maintained over the period between the leading edge and the peak potential point of the sustain pulse IP and applies it to the column electrodes D₁-Dₘ. Incidentally, the auxiliary pulse HP has a peak equal in potential to the peak of the pixel data pulse.

In the sustain stage I of the sub-field SF1, a sustain discharge is caused between the row electrodes X and Y in the discharge cell PC staying in on-mode, by the application of sustain and auxiliary pulses IP, HP. By illuminating the light from the phosphor layer 17 to the external through the front transparent substrate 10 due to the sustain discharge, light emission is effected for display correspondingly to the intensity weight for the sub-field SF1. In response to the application of the sustain pulse IP, a discharge is caused also between the row electrode Y and the column electrode D in the discharge cell PC staying in on-mode. By the discharge and the sustain discharge, wall charges are formed negative around the row electrode Y and positive around the row and column electrodes X, D in the discharge cell PC.

After the application of the sustain pulse IP, the Y-electrode driver 53 applies a wall-charge adjusting pulse CP having a negative peak potential moderate in potential change at the leading edge with the passage of time as shown in FIG. 8, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In the selective erase address stage W₀ of each of the sub-fields SF2-SF14, the Y-electrode driver 53 applies an erase scan pulse SP_{D} having such a negative peak potential as shown in FIG. 8 selectively, in order, to the row electrode Y₁-Yₙ while applying a base pulse BP⁺ having a predetermined positive peak potential to the row electrodes Y₁-Yₙ. The base pulse BP⁺ is set at a potential that can prevent against an erroneous discharge between the row electrodes X and Y over the execution period of the selective erase address stage W₀. Over the execution period of the selective erase address stage W₀, the X-electrode driver 51 sets the row electrodes X₁-Xₙ at the ground potential (0 volt). In the selective erase address stage W_{D}, the address driver 55 first converts the pixel-drive data bit corresponding to the relevant sub-field SF into a pixel data pulse DP having a pulse voltage suited for the logic level thereof. For example, when supplied a pixel-drive data bit having a logic level 1 for changing the discharge cell PC from on-mode to off-mode, the address driver 55 converts it into a pixel data pulse DP having a positive peak potential. Meanwhile, when supplied a pixel-drive data bit having a logic level 0 for maintaining the current state of the discharge cell PC, it is converted into a pixel data pulse DP having a low voltage (0 voltage). The address driver 55 applies the pixel data pulse DP in an amount of one display line (m in the number) per time to the column electrodes D₁-Dₘ synchronously with the application timing of each erase scan pulse SP_{D}. Simultaneously with the erase scan pulse SP_{D}, a selective erase address discharge is caused between the column electrode D and the row electrode Y of the discharge cell PC to which has been applied a pixel-data pulse high in voltage and positive in polarity. By the selective erase address discharge, the discharge cell PC is formed with wall charges positively around the row electrodes Y and X and negatively around the column electrode D, i.e. set in off-mode. Meanwhile, simultaneously with the erase scan pulse SP_{D}, a selective write address discharge as in the foregoing is not caused between the column electrode D and the row electrode Y in the discharge cell PC to which has been applied the pixel data pulse DP low in voltage (0 volt). Therefore, the relevant discharge cell PC maintains the state immediately before (on or off-mode).

In the sustain stage I of each of the sub-fields SF2-SF14, the X-electrode and Y-electrode drivers 51, 53 apply sustain pulses IP each having a positive peak potential alternately to the row electrodes X and Y as shown in FIG. 8, repeatedly in the number of times corresponding to the intensity weight for the sub-field (even number of times). Incidentally, in the sustain stage I of the SF immediately succeeding the SF having an intensity weight smaller than a predetermined value out of the sub-fields SF2-SF14, the address driver 55 generates a positive auxiliary pulse HP nearly simultaneously with the first-applied sustain pulse IP and applies it to the column electrodes D₁-Dₘ. For example, the address driver 55 applies to the column electrode D an auxiliary pulse HP for maintaining a positive peak potential over the period between the sustain pulse IP leading edge and the peak potential point of the sustain pulse IP first applied as shown in FIG. 8, in the sustain stage I of the SF immediately succeeding the SF to which the application count of the sustain pulse is assigned as 10 or smaller (SF2 in FIG. 8). Note that the auxiliary pulse HP has a peak equal in potential to the peak of the pixel data pulse.

In the sustain stage I of each of the sub-fields SF2-SF14, a sustain discharge is caused between the row electrodes X and Y in the discharge cell PC set in on-mode each time such a sustain pulse IP is applied as shown in FIG. 8. On this occasion, by illuminating the light from the phosphor layer 17 to the outside through the front transparent substrate 10 due to the sustain discharge, light emission is effected for display in the number of times corresponding to the intensity weight for the relevant sub-field SF.

In the sustain stage I of each of the sub-fields SF2-SF14, wall charges are formed negative around the row electrode Y and positive around the row electrode X and column electrode D in the discharge cell PC where a sustain discharge has been caused by the last sustain pulse IP. After the application of the last sustain pulse IP, the Y-electrode driver 53 applies a wall-charge adjusting pulse CP having a negative peak potential moderate in change at the leading edge with the passage of time as shown in FIG. 8, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In the last end of the last sub-field SF14, the Y-electrode driver 53 applies an erase pulse EP having a negative peak potential to all the row electrodes Y₁-Yₙ. By the application of the erase pulse EP, an erase discharge is caused only in the discharge cell PC staying in on-mode. By the erase discharge, the discharge cell PC staying in on-mode transits into off-mode.

The driving like the above is implemented based on such pixel drive data GD with 15 patterns as shown in FIG. 6. With such driving, a write address discharge (indicated with a double circle) is first caused in every discharge cell PC in the beginning sub-field SF1 as shown in FIG. 6 excepting the case to represent an intensity level 0 (first level). The relevant discharge cell PC is set in on-mode. Thereafter, a selective erase address discharge (indicated with a black circle) is caused only in the selective erase address stage W₀ of one of the sub-fields SF2-SF14, followed by the setting of the discharge cell PC in off-mode. Namely, each discharge cell PC is set in on-mode in each of the successive sub-fields correspondingly to a halfway light intensity to represent. Light emission (indicated with an open circle) is repeatedly caused by the sustain discharge, in the number of times assigned to each of the sub-fields. On this occasion, visual perception is done at the light intensity corresponding to the total number of sustain discharges caused within the one-field (or one-frame) display period. With 15 emission patterns based on first to fifteenth level drive as shown in FIG. 6, halfway intensity can be represented in 15 levels corresponding to the total number of times of sustain discharges caused in the sub-fields, as indicated with open circles. According to such driving, because no inverted regions are encountered in the emission patterns (on state, off state) on one screen within the one-field display period, a false image is prevented from occurring in such a state.

Meanwhile, in the driving shown in FIG. 8, the sustain pulses IP are applied the even number of times in the sustain stage I of each of the sub-fields SF2-SF14. Accordingly, because wall charges are formed negative around the row electrode Y and positive around the column electrode D immediately after the termination of the sustain stage I, a discharge with the column electrode D serving as an anode (hereinafter, referred to as anode-at-column discharge) is available between the column electrode D and the row electrode Y in the selective erase address stage W_{D} to be executed following the sustain stage I. Accordingly, the column electrode D is merely applied with positive pulses thus preventing the address driver 55 from increasing the cost.

Incidentally, in the driving shown in FIGS. 7 and 8, all the discharge cell PCs are first initialized into off-mode by reset discharge in the beginning sub-field SF1, to cause a write address discharge in the discharge cells PCs into on-mode excepting the cases of making a black display (intensity level 0). In the case of making a black display based on such driving, a reset discharge only is made in the beginning sub-field SF1 throughout the one-field display period. Accordingly, as compared to the case employing the driving to cause a selective erase address discharge that all the discharge cells are initialized into on-mode by reset discharge and then transited into off-mode, the discharges to cause within one-field display period is reduced in the number of times. Accordingly, such driving can improve the contrast upon displaying a dark image, i.e. so-called dark contrast.

In the driving shown in FIGS. 7 and 8, cathode-at-column discharge is caused as a first reset discharge to flow current from the row electrode Y toward the column electrode D, by applying voltage to between the column electrode D as a cathode and the row electrode Y as an anode. During the first reset discharge, the positive ions in the discharge gas bombard against the MgO crystal as a secondary-electron emission material contained in such a phosphor layer 17 as shown in FIG. 5 when traveling toward the column electrode D. Particularly, in the PDP 50 of the plasma display apparatus shown in FIG. 1, the probability of bombardment against positive ions is raised by exposing the MgO crystal in a discharge space as shown in FIG. 5, thus efficiently giving off secondary electrons in a discharge space. By doing so, the discharge cell PC is lowered in discharge start voltage owing to the priming action based on such secondary electrons, thus making it possible to cause a comparatively weak reset voltage. Accordingly, display is available with improved dark contrast because the weakened reset discharge lowers the intensity of light emission as caused by the discharge.

In the driving shown in FIG. 8, the first reset discharge is caused between the row electrode Y formed on the side of the front transparent substrate 10 as shown in FIG. 3 and the column electrode D formed on the back substrate 14. As compared to the case of a reset discharge caused between the row electrodes X and Y both formed on the front transparent substrate 10, dark contrast can be further improved because of reduced amount of the discharge light to be released to the outside through the front transparent substrate 10.

In the driving shown in FIG. 8, in the sustain stage I of the sub-field SF1 smallest in intensity weight, sustain discharge is caused only once by applying only once a sustain pulse IP, thereby improving the display reproducibility for a low-intensity image. Incidentally, after ceasing the sustain discharge caused by the once sustain pulse IP, wall charges are formed negative around the row electrode Y and positive around the column electrode D. This makes it possible to cause an anode-at-column discharge as a selective erase address discharge in the selective erase address stage W_{D} of the sub-field SF2 when implementing the driving shown in FIG. 8.

Meanwhile, in the PDP 50 shown in FIG. 1, CL-emission MgO crystal is contained as a secondary-electron emission material also in the phosphor layer 17 formed on the back substrate 14 besides in the magnesium oxide layer 13 formed on the front transparent substrate 10 in each discharge cell PC.

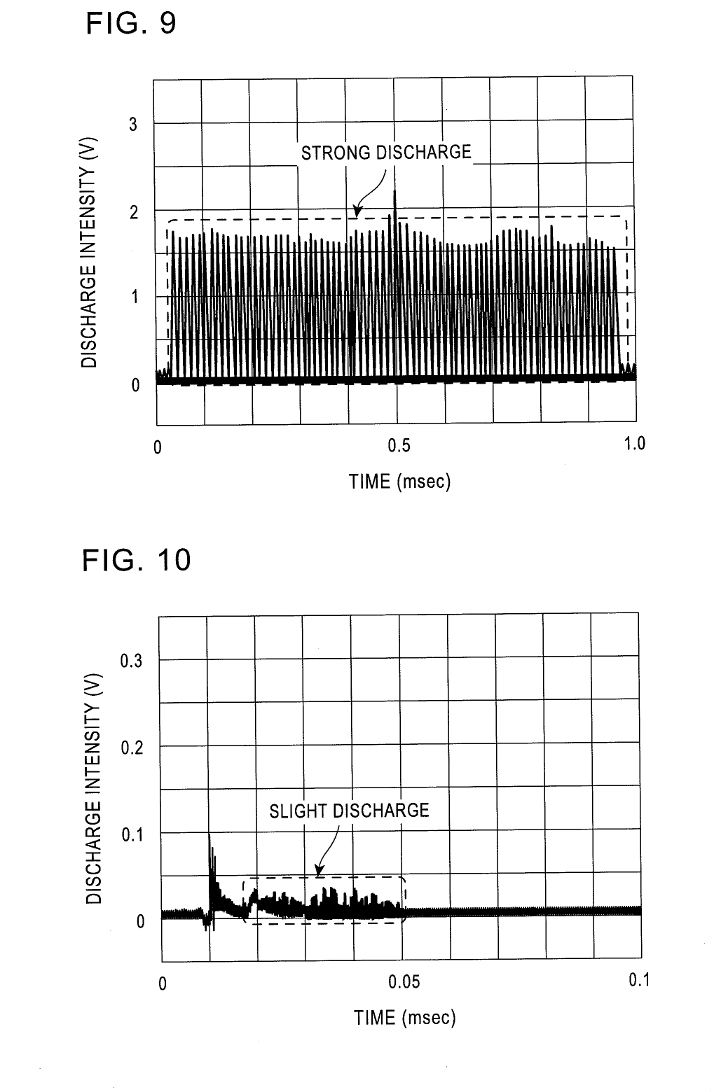

The operational effect to be enjoyed by employing the above structure is explained in the following while referring to FIGS. 9 and 10.

FIG. 9 is a figure representing the intensity change of an cathode-at-column discharge caused by applying such a reset pulse RP_{Y1} as shown in FIG. 8 to the existing PDP containing a CL-emission MgO crystal only in the magnesium layer 13 out of the magnesium oxide layer 13 and the phosphor layer 17.

Meanwhile, FIG. 10 is a figure representing the intensity change of a cathode-at-column discharge caused by applying such a reset pulse RP_{Y1} to the PDP containing a CL-emission MgO crystal in both the magnesium layer 13 and the phosphor layer 17.

According to the existing PDP, the cathode-at-column discharge continues comparatively intensely for 1 [ms] or longer due to the application of the reset pulse RP_{Y1}, as shown in FIG. 9. However, in the PDP 50 according to the present embodiment, the cathode-at-column discharge ceases within approximately 0.04 [ms], as shown in FIG. 10. Namely, discharge delay time can be greatly reduced in the cathode-at-column discharge as compared to that of the existing PDP.

Accordingly, in case a cathode-at-column discharge is caused by applying such a reset pulse RP_{Y1} having a waveform moderate in potential change at the pulse leading edge as shown in FIG. 8 to the row electrode Y of the PDP 50, the discharge ceases before the reset pulse RP_{Y1} reaches its peak potential. Thus, the discharge intensity lowers greatly as shown in FIG. 10 because the cathode-at-column discharge ceases while the voltage applied to between the row electrode and the column electrode is still low.

Namely, a cathode-at-column discharge can be caused further weakened in discharge intensity by applying such a reset pulse RP_{Y1} as shown in FIG. 8, for example, having a waveform moderate in potential change at the pulse leading edge to the PDP 50 containing a CL-emission MgO crystal not only in the magnesium oxide layer 13 but also in the phosphor layer 17. Accordingly, because of the capability of causing, as a reset discharge, a cathode-at-column discharge extremely weak in discharge intensity like this, the resulting image can be improved in contrast, particularly in the dark contrast upon displaying a dark image.

Here, in the driving shown in FIG. 8, in the sustain stage I of the SF immediately succeeding the SF smaller in intensity weight out of the sub-fields SF, an auxiliary pulse HP having a peak potential identical in polarity to a sustain pulse IP to be first applied is applied only once in the beginning thereof and nearly simultaneously with the IP.

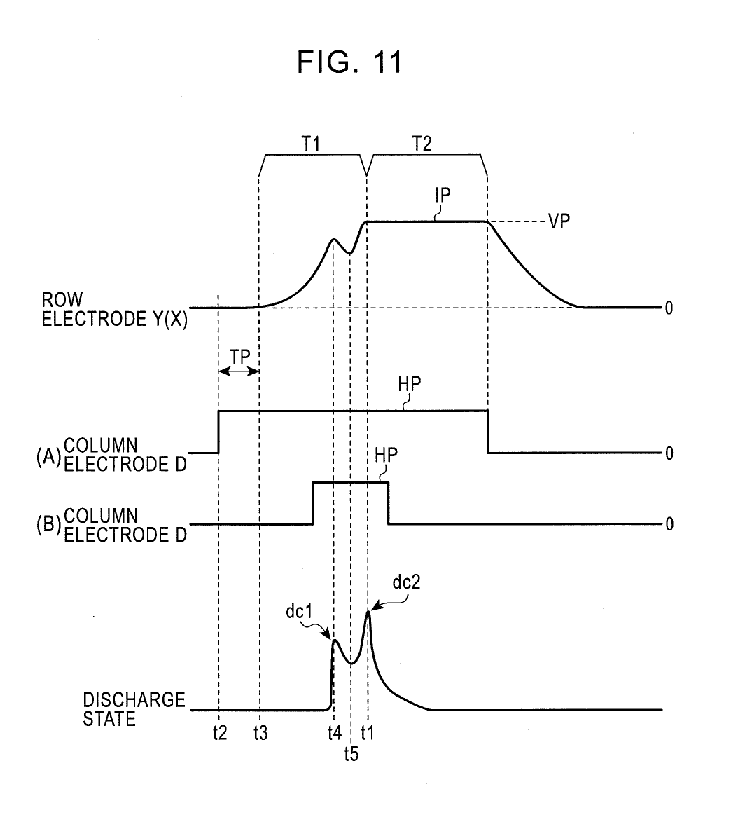

FIG. 11 is a figure representing the application timing of the auxiliary pulse HP relative to the sustain pulse IP and the timing of a discharge occurrence.

The address driver 55 applies an auxiliary pulse HP to all the column electrodes D in such timing as shown in FIG. 11A, for example. Namely, the auxiliary pulse HP is started applied to all the column electrodes D at the time t2 immediately before application of the sustain pulse IP. In this case, the auxiliary pulse HP is maintained in its positive peak potential over the duration of a predetermined period TP, a leading edge period T1 of the auxiliary pulse IP and a peak potential period T2, from the time t2. Incidentally, the leading edge period T1 is a duration that the potential of the sustain pulse IP moderately increases with the passage of time from the 0-volt state at the time t3 and reaches the peak potential VP. Meanwhile, the peak potential period T2 is a duration that the sustain pulse IP is maintained at the peak potential VP. Namely, the auxiliary pulse HP is maintained at its positive peak potential over the duration from the time t2, earlier by a predetermined marginal period TP than the time t3 as a start time of the leading edge period T1 of the sustain pulse IP, over to a termination time of the peak potential period T2 of the sustain pulse IP.

Here, when the sustain pulse IP is applied to the row electrode (X or Y) and the auxiliary pulse HP is applied to the column electrode D, a first round of discharge (dc1) is caused between the row electrodes X and Y in the discharge cell PC staying in on-mode at time t4 in the leading edge period T1 of the sustain pulse IP, as shown in FIG. 11. On this occasion, the potential of the sustain pulse IP temporarily drops as shown in FIG. 11 due to the current flow through between the row electrodes X and Y caused by the discharge dc1. However, because the potential on the row electrodes (X, Y) is clamped at the peak potential VP of the sustain pulse IP at the later time t5, the potential of the sustain pulse IP again rises toward the peak potential VP. Thereafter, when the potential of the sustain pulse IP reaches the peak potential VP at the time t1 as shown in FIG. 11, a second round of discharge (dc2) is caused between the row electrodes X and Y of the discharge cell PC staying in on-mode.

In this manner, in case the auxiliary pulse HP is applied together with the sustain pulse IP, a first round of discharge is first caused at the time of the leading edge of the sustain pulse IP, followed by an occurrence of a second round of discharge at the time the potential of the sustain pulse IP reaches its peak value.

The operational effect to be enjoyed by implementing such driving as shown in FIG. 11 is explained in the following.

When a sustain pulse IP having a positive peak potential is applied to the row electrode Y (or X), electric field arises between the row electrodes X and Y and between the row electrode Y (or X) and the column electrode D. However, in case applying to the column electrode D an auxiliary pulse HP having a peak potential identical in polarity to the peak potential of the sustain pulse IP in this duration, the electric field is weakened between the row electrode Y (or X) and the column electrode D. Thereupon, the electric field is intensified between the row electrodes X and Y in an amount corresponding to the weakening of the electric field between the row electrode Y (or X) and the column electrode D, thus readily causing a discharge between the row electrodes X and Y.

Accordingly, even where the delay of discharge occurs immediately before thereof due to the reduced charged grains remaining in the discharge cell PC, discharge can be caused successively twice (dc1, dc2) as a sustain discharge as shown in FIG. 11 without increasing the leading edge period T1 of the sustain pulse IP to a required degree or longer. On this occasion, the display light illuminated by the twice discharges has a light intensity nearly uniform in level throughout all the discharge cells PCs, thus eliminating brightness irregularity.

Incidentally, because it is satisfactory to cause twice discharges (dc1, dc2) successively as shown in FIG. 11 by the application of an auxiliary pulse HP, the address driver 55 may apply an auxiliary pulse HP to all the row electrodes D in such timing as shown in (B) instead of that of (A) of FIG. 11. Namely, it is satisfactory to apply an auxiliary pulse HP for maintaining the positive peak potential over the duration including a time t4 that a first round of discharge (dc1) occurs and a time t1 that the sustain pulse reaches its peak potential in the leading edge period T1, after a start time t3 of the leading edge period T1 of the sustain pulse IP.

In the meanwhile, if all sustain discharges are provided as twice discharges (dc1, dc2) by applying an auxiliary pulse HP simultaneously with every sustain pulses IP to be applied within the one-frame display period, a problem arises that consumption power increases.

For this reason, in order to reduce the consumption power, auxiliary pulses HP are applied simultaneously with sustain pulses IP only when the delay of discharge is conspicuous. Here, the time the delay of discharge is conspicuous, i.e. the time the charged grains formed in the discharge cell PC are reduced by the sustain discharge is at (a) the execution time of the sustain stage in the beginning sub-field, (b) the extreme beginning of the sustain stage of each of the sub-fields, and (c) the execution of the sustain stage in the sub-field immediately succeeding the sub-field that sustain pulses are comparatively less assigned in the number of times.

In the driving shown in FIG. 8, auxiliary pulses HP are applied simultaneously with the sustain pulse IP, only in the extreme beginning (time the first sustain pulse IP is applied) in the sustain stage of the beginning sub-field SF1 and of the sub-field immediately succeeding the sub-field that sustain pulse applications are in a predetermined number of times or smaller.

Consequently, according to the driving shown in FIG. 8, brightness irregularity can be eliminated upon displaying an image of low luminance without the increase of power consumption.

Incidentally, the auxiliary pulses HP may be applied in the extreme beginnings of the respective sustain stages of all the sub-fields within the one-frame display period. Otherwise, auxiliary pulses HP may be applied respectively simultaneously with the sustain pulses IP to be repeatedly applied in the sustain stages of the sub-fields each immediately succeeding the sub-field that sustain-pulse are to be assigned applied a predetermined number of times or smaller.

In order to eliminate brightness irregularity, sustain-pulse waveform control may be executed together with the application of the auxiliary pulse HP, as in the following manner.

Namely, in case a multiplicity of sustain discharges are caused simultaneously in the sustain stage I, a large amount of current instantaneously flows through the row electrodes (X, Y) resulting from the currents of respective discharges at discharge cells, thus possibly causing a distortion in the sustain pulse waveform. Thus, the potential of the sustain pulse applied upon sustain discharge is given not constant between the discharge cells, thus raising a problem that the discharge-based light intensity is non-uniform in level upon light emission with a result that brightness irregularity is visually perceived.

For this reason, auxiliary pulses HP are applied in the timing shown in FIG. 11A or 11B relatively to the sustain pulse IP to be applied in the extreme beginning of the sustain stage. Moreover, the leading edge period T1 of each sustain pulse IP is changed in length depending upon the number of cells being set in on-mode of the discharge cells PC_{1.1}-PC_{n,m}.

Namely, the drive control circuit 56 first counts the total number of the discharge cells PCs to set to on-mode in the relevant sub-field on a sub-field-by-sub-field basis depending upon such pixel drive data GD as shown in FIG. 6. Then, the drive control circuit 56 controls the X-electrode and Y-electrode drivers 51, 53 to increase the leading edge period T1 of the sustain pulse IP as shown in FIG. 11 longer with the increase of the total number of discharge cells PCs staying in on-mode. Under such control, the leading edge period T1 of such a sustain pulse IP, i.e. the time from a 0-volt state over to a peak potential VP, increases with the increase of the total number of the discharge cells PCs staying in on-mode. Here, because there are variations in discharge start voltage between the discharge cells due to the variations in the manufacture for example, the discharge cells vary in discharge timing as the leading edge period T1 of the sustain pulse IP increases. This reduces the current instantaneous flowing through the row electrode (X, Y) at each discharge time point, thus suppressing the distortion of the sustain-pulse waveform. As a result, brightness irregularity is eliminated.

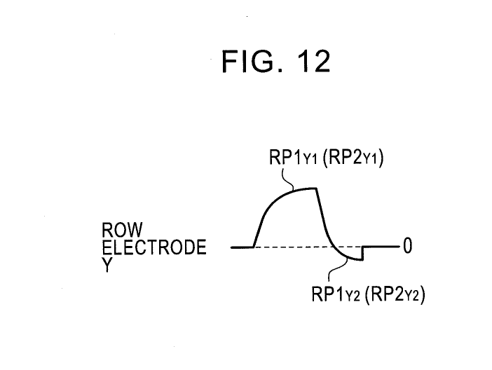

Although the potential change rate (inclination) of the reset pulse RP_{Y1} at the leading edge is taken constant with respect to the passage of time in the embodiment shown in FIG. 8, the waveform may be in such a form as gradually changing in inclination with the passage of time, as a pulse RP1_{Y1}(RP2_{Y1}) shown in FIG. 12.

Although reset discharges were caused simultaneously at all the pixel cells in the reset stage R shown in FIG. 8, reset discharges may be executed differently in time on the basis of the pixel cells formed by a plurality of pixel cells.

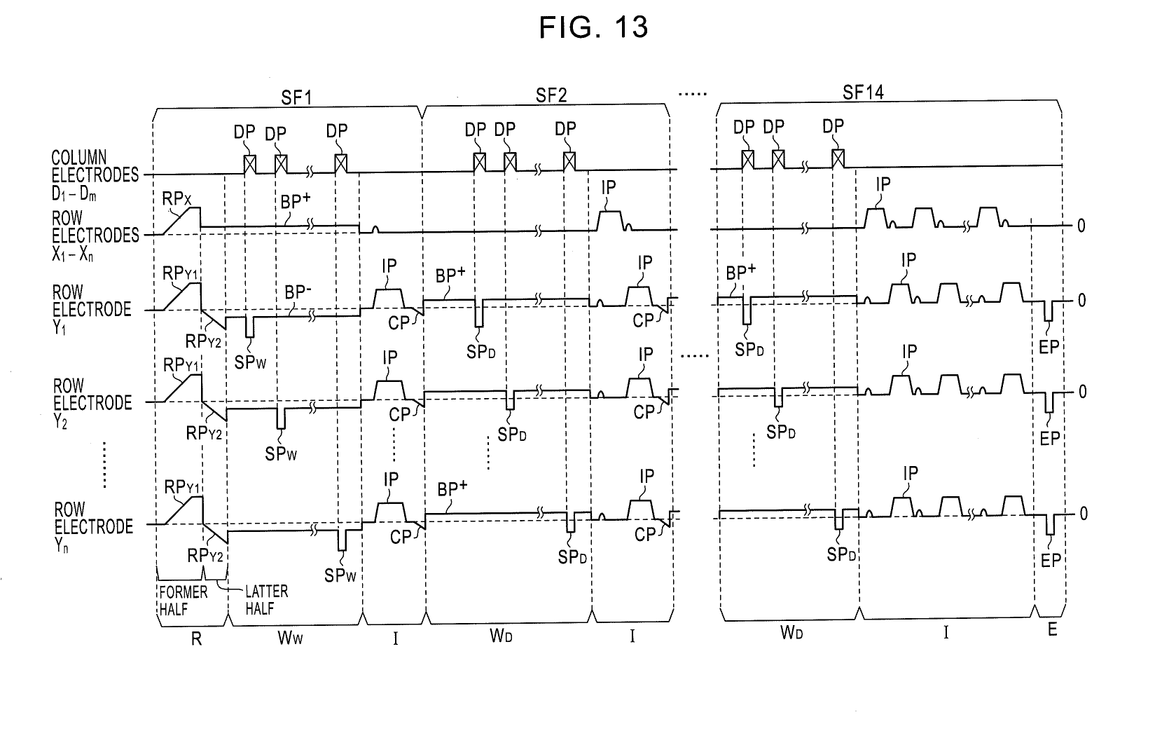

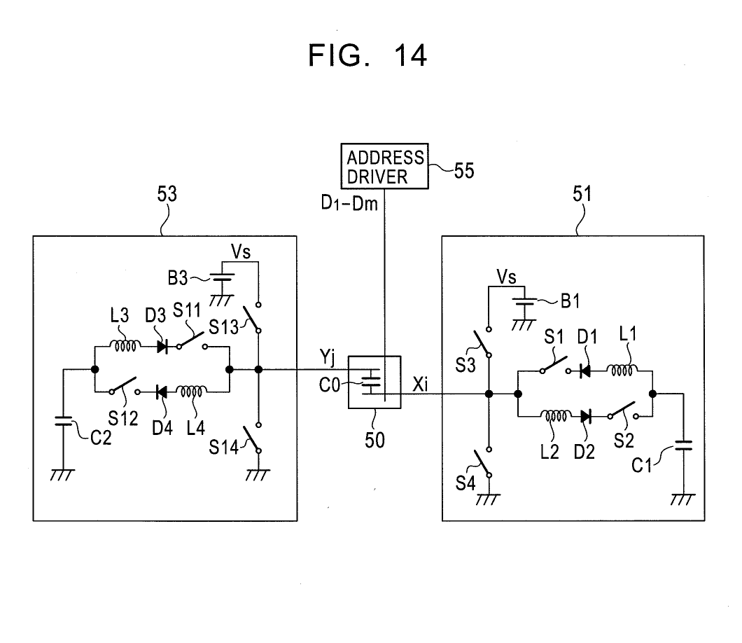

The X-electrode driver 51, the Y-electrode driver 53 and the address driver 55, in FIG. 1, may produce such various drive pulses as shown in FIG. 13 depending upon the various control signals supplied from the drive control circuit 56, and supply those to the column and row electrodes D, X and Y of the PDP 50.

FIG. 13 representatively show the operations only in the beginning sub-field SF1, the following sub-field SF2 and the last sub-field, out of the sub-fields SF1-SF14 shown in FIG. 7.

The application of various drive pulses, in the reset and selective write address stages R, W_{W} of the sub-field SF1, is similar to that of FIG. 8.

In the sustain stage I of the sub-field SF1, the Y-electrode driver 53 generates a sustain pulse IP having a positive peak potential in an amount of one pulse and applies it to the row electrodes Y₁-Yₙ simultaneously, as shown in FIG. 13. The X-driver 51 places the row electrodes X₁-Xₙ in a floating state in a rise period of the sustain pulse IP applied to the row electrodes Y₁-Yₙ. In the remaining duration of sustain pulse IP application, the row electrodes X₁-Xₙ are placed in a ground-potential (0 volt) state.

In the sustain stage I of the sub-field SF1, a sustain discharge is caused between the row electrodes X and Y, in the discharge cell PC staying in on-mode, by the application of the sustain pulse IP. By illuminating the light from the phosphor layer 17 to the outside through the front transparent substrate 10 due to the sustain discharge, light emission is effected for display correspondingly to the intensity weight for the relevant sub-field SF. Meanwhile, a discharge is caused also between the row electrode Y and the column electrode D in the discharge cell PC staying in on-mode. By the discharge and the sustain discharge, wall charges are formed negative around the row electrode Y and positive around the row electrode X and column electrode D in the discharge cell PC.

After the application of the sustain pulse IP, the Y-electrode driver 53 applies a wall-charge adjusting pulse CP having a negative peak potential moderate in potential change at the leading edge with the passage of time as shown in FIG. 8, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

The application of various drive pulses, in the selective erase address stage W₀ of each of the sub-fields SF2-SF14 and in the erase period E of the sub-field SF 14, is similar to that of FIG. 8.

In the sustain stage I of each of the sub-fields SF2-SF14, the X-electrode and Y-electrode drivers 51, 53 apply sustain pulses IP each having a positive peak potential alternately to the row electrodes X and Y as shown in FIG. 13, repeatedly in the number of times corresponding to the intensity weight for the sub-field (even number of times). The X-driver 51 places the row electrodes X₁-Xₙ in a floating state in a rise period of the sustain pulse IP applied to the row electrodes Y₁-Yₙ. In the remaining duration of sustain pulse IP application in the later, the row electrodes X₁-Xₙ are placed in a ground-potential (0 volt) state. The Y-driver 53 places the row electrodes Y₁-Yₙ in a floating state in a rise period of the sustain pulse IP applied to the row electrodes X₁-Xₙ. In the remaining duration of sustain pulse IP application in the later, the row electrodes Y₁-Yₙ are placed in a ground-potential state.

In the sustain stage I of each of the sub-fields SF2-SF14, a sustain discharge is caused between the row electrodes X and Y in the discharge cell PC set in on-mode each time the sustain pulse is applied as shown in FIG. 13. On this occasion, by illuminating the light from the phosphor layer 17 to the outside through the front transparent substrate 10 due to the sustain discharge, light emission is effected for display in the number of times corresponding to the intensity weight for the relevant sub-field SF.

Here, in the sustain stage I of each of the sub-fields SF2-SF14, wall charges are formed negative around the row electrode Y and positive around the row and column electrodes X, D in the discharge cell PC where sustain discharge occurred by the last sustain pulse IP. After the application of the last sustain pulse IP, the Y-electrode driver 53 applies a wall-charge adjusting pulse CP having a negative peak potential moderate in potential change at the leading edge with the passage of time as shown in FIG. 13, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

FIG. 14 shows a configuration of respective sustain pulse generating circuits of the X-electrode and Y-electrode drivers 51, 53. The sustain pulse generating circuits are for the row electrodes Xj, Yj of the discharge cells PC_{j,1}-PC_{j,m} on the j-th display line as one of the first to n-th display lines of the PDP 50. The circuit on the row electrode Xⱼ side has switch elements S1, S2, S3, S4, coils L1, L2, diodes D1, D2, a capacitor C1 and a direct-current power source B1. In the circuit on the row electrode Xⱼ side, there are connected in parallel a series circuit formed by the switch element S1, the diode D1 and the coil L1 and a series circuit formed by the coil L2, the diode D2 and the switch element S12. Those series circuits have respective one ends connected to the row electrode Xⱼ and the other ends being grounded commonly through the capacitor C1. The one ends are connected to the supply line of a voltage Vs from the power source B1 through the switch element S3 and grounded through the switch element S4.

The circuit on the row electrode Yj side has switch elements S11, S12, S13, S14, coils L3, L4, diodes D3, D4, a capacitor C2 and a direct-current power source B3. Those components are in the similar connection to those of the circuit on the row electrode Xⱼ side. Showing is made as an equivalent circuit connecting a capacitor C0 between the row electrodes Xj, Yj. The capacitors C1, C2 each have a capacitance fully greater as compared to the capacitance of the capacitor C0.

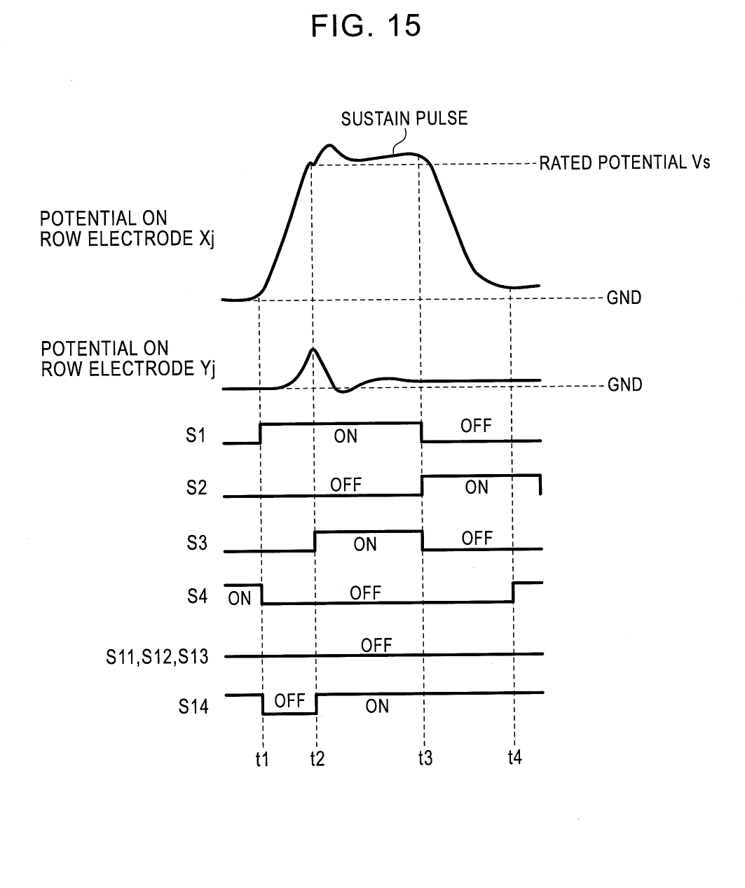

In the sustain pulse generating circuit, when applying a sustain pulse to the row electrode Xj, the switch element S1 is turned on at time t1. At this time, the other switch elements are off. In case the switch element S1 is turned on at a terminal-to-terminal voltage 0V of the capacitor C0, a current flows from the capacitor C1 to the capacitor C0 through the coil L1, the diode D1 and the switch element S1 due to the resonant action of the coil L1 and the capacitor C0. Due to this, the potential on the row electrode Xⱼ rises as shown in FIG. 15, to form a rise portion for a sustain pulse. The potential on the row electrode Yj, capacitance-coupled by the row electrode Xj and the capacitor C0, rises with a somewhat delay relatively to the potential rise at the row electrode Xj. The row electrode Yj is in a floating state at the potential rise on the row electrodes Xj, Yj, i.e. in a rise of the sustain pulse applied to the row electrode Xj.

The switch elements S3, S14 turn on at time t2 the potential on the row electrode Xj reaches nearly Vs. Due to this, the potential Vs is directly applied to the row electrode Xj while the row electrode Yj transits from the floating state into a ground state. Namely, there becomes a state that the output voltage Vs of the power source B1 is applied to between the row electrodes Xj and Yj, thus forming a top portion for a sustain pulse. The potential on the row electrode Yj gradually lowers into a ground potential.

The Vs application state started at time t2 continues up to time t3. At the time t3, the switch elements S1, S3 turn off and, instead, the switch element S2 turns on. Due to this, a current flows from the ground to the capacitor C1 by way of the switch S14, the capacitor C0, the coil L2, the diode D2 and the switch S2 due to the resonant action of the coil L2 and the capacitor C0. Due to this, the potential on the row electrode Xⱼ falls to form a fall portion of a sustain pulse. At time t4 the sustain pulse nearly falls, the switch element S4 turns on. The switch element S2 turns off at time t5 immediately succeeding that time.

In this manner, because the potential on the row electrode Yj follows the potential on the row electrode Xj in the course of potential rise at the row electrode Xj, the voltage across the row electrodes Xj and Yj does not reach the discharge start voltage for all the discharge cells PC_{j,1}-PC_{j,m} on the j-th display line, thus not causing a sustain discharge. Thereafter, in the duration of time t2-t3 after the row electrode Yj reached the rated potential Vs, the row electrode Yⱼ is grounded. Accordingly, sustain discharge occurs in all the discharge cells PC_{1,1}-PC_{j,m} after reaching the rated potential Vs of the row electrode Xj. Light intensity can be obtained nearly equal even if discharge characteristic differs from discharge cell to discharge cell.

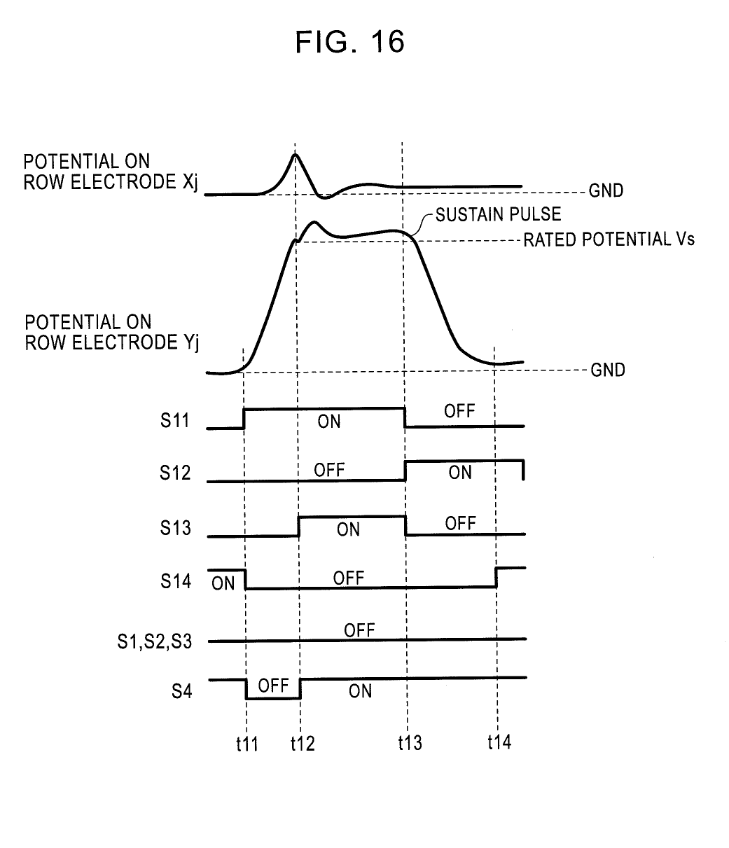

The application of a sustain pulse to the row electrode Yj is similar to the application thereof to the row electrode Xj, i.e. the switch element S11 is turned on at time t11. At this time, the other switch elements are off. When the switch element S11 turns on at a terminal-to-terminal voltage 0V of the capacitor C0, a current flows from the capacitor C2 to the capacitor C0 by way of the coil L3, the diode D3 and the switch element S11 due to the resonant action of the coil L3 and the capacitor C0. Due to this, the potential on the row electrode Yj rises as shown in FIG. 16, to form a rise portion for a sustain pulse. The potential on the row electrode Xj, capacitance-coupled by the row electrode Yⱼ and the capacitor C0, rises with a somewhat delay relatively to the potential rise at the row electrode Yⱼ. The row electrode Xj is in a floating state at the potential rise on the row electrodes Xj, Yj, i.e. in a rise of the sustain pulse applied to the row electrode Yj.

The switch elements S13, S4 turn on at time t12 the potential on the row electrode Yj reaches nearly Vs. Due to this, the potential Vs is directly applied to the row electrode Yⱼ while the row electrode Xj transits from the floating state into a ground state. Namely, there becomes a state that the output voltage Vs of the power source B3 is applied to between the row electrodes Yj and Xj, thus forming a top portion for a sustain pulse. The potential on the row electrode Xⱼ gradually lowers into a ground potential.

The Vs application state started at time t12 continues up to time t13. At the time t13, the switch elements S11, S13 turn off and, instead, the switch element S12 turns on. Due to this, a resonant current flows from the ground to the capacitor C2 by way of the switch S4, the capacitor C0, the coil L4, the diode D4 and the switch S12 due to the resonant action of the coil L4 and the capacitor C0. Due to this, the potential on the row electrode Yj falls to form a fall portion of a sustain pulse. At time t14 the sustain pulse nearly falls, the switch element S14 turns on. The switch element S12 turns off at time t15 immediately succeeding that time.

Accordingly, the voltage across the row electrodes Xⱼ and Yj does not reach the discharge start voltage in all the discharge cells PC_{j,1}-PC_{j,m} on the j-th display line in the course of potential rise at the row electrode Yj, thus not causing a sustain discharge. Meanwhile, in the duration of time t12-t13 after the row electrode Yj reached the rated potential Vs, a sustain discharge occurs after reached the rated potential Vs of the row electrode Yj due to the grounding of the row electrode Yj. Light intensity can be obtained nearly equal even if discharge characteristic differs from discharge cell to discharge cell.

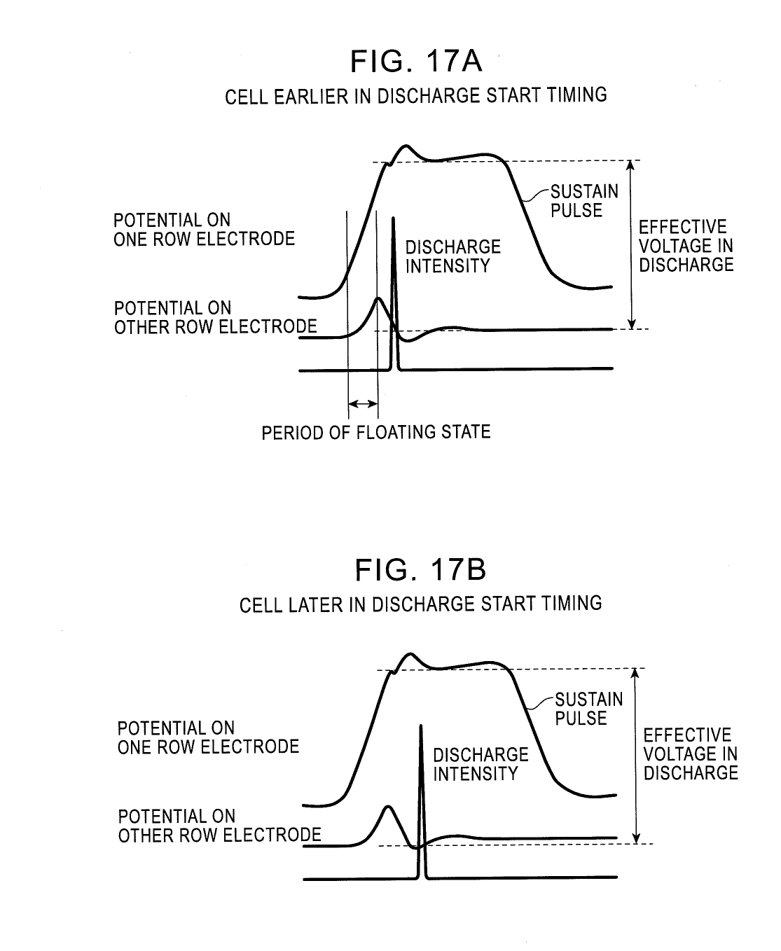

Of the discharge cells, there are those earlier in discharge start timing as shown in FIG. 17A and those later in discharge start timing as shown in FIG. 17B. Even for the cells different in discharge start timing like the above, sustain discharge occurs after applying a rated voltage Vs to between the row electrodes through canceling, during the potential rise at one of the row electrodes constituting a row electrode pair, the floating state placed in the other row electrode. In the both cases, the voltage is equally applied to between the row electrodes (effective voltage upon discharge) during a sustain discharge, thus providing a sustain discharge nearly uniform in intensity and hence in the level of the brightness based on sustain discharge.

Here, on the other row electrode, there is a region where overshoot occurs toward a negative potential smaller than the ground potential (0 V) after placed in a ground state from the floating state. In the cell later in discharge start timing, a sustain discharge is caused in an overshoot region as shown in FIG. 17B because the discharge arises with a somewhat delay relative to the grounding. Accordingly, even for the cell later in discharge start timing, the intensity of light emission can be prevented from lowering without the lower in the effective voltage due to such overshoot during discharge.

In the PDP 50, sustain pulse application is to be similarly done on all the first to n-th display lines including the j-th display line, thus providing substantially uniform the intensity of sustain discharge at all the discharge cells PC_{1,1}-PC_{n,m}. Therefore, even where cumulative use period is long and cell-based discharge characteristics vary, image display is available well while suppressing the intensity variations of sustain discharge.

In the above embodiment, the turning on of the switch element S1 and the turning off of the switch element S14 are at the same time t1, which is not limitative. For example, the turning off of the switch element S14 may be after the turning on of the switch element S1. Meanwhile, the turning on of the switch element S3 and the turning on of the switch element S14 are at the same time t2, which is not limitative. For example, the turning on of the switch element S14 may be before or after the turning on of the switch element S3. This is true for the turning-on/off timing as to the time t11, t12 for the switch element S11, s13, S4 shown in FIG. 16.

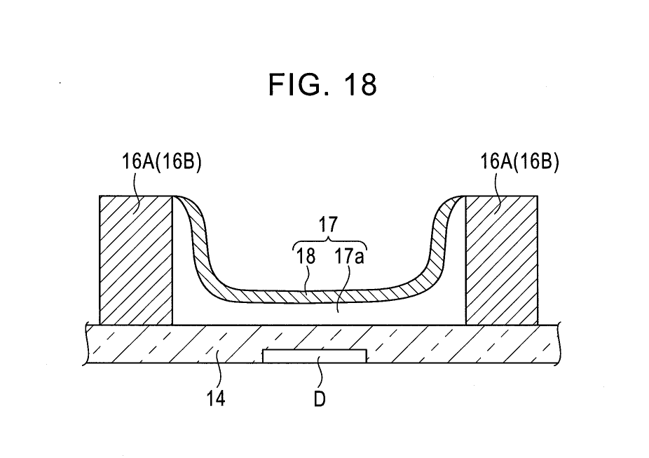

Meanwhile, the PDP pixel cell in FIG. 2 contains an MgO crystal in the phosphor layer 17 provided closer to the back substrate 14 of the PDP 50. Alternatively, the phosphor layer 17 may be formed by an overlay structure of a phosphor particle layer 17a formed by phosphor grains and a secondary-electron emission layer 18 formed of a secondary-electron emission material, as shown in FIG. 18. In such a case, the secondary-electron emission layer 18 may be formed by laying a crystal of secondary-electron emission material (e.g. MgO crystal containing a CL-emission MgO crystal) over the surface of a phosphor particle layer 17a. Otherwise, it may be formed by film-forming a secondary-electron emission material.

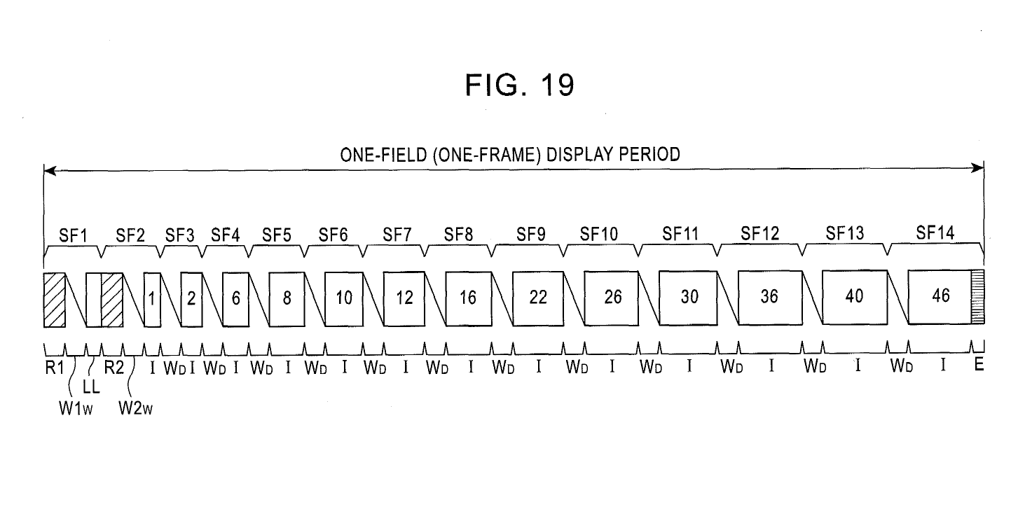

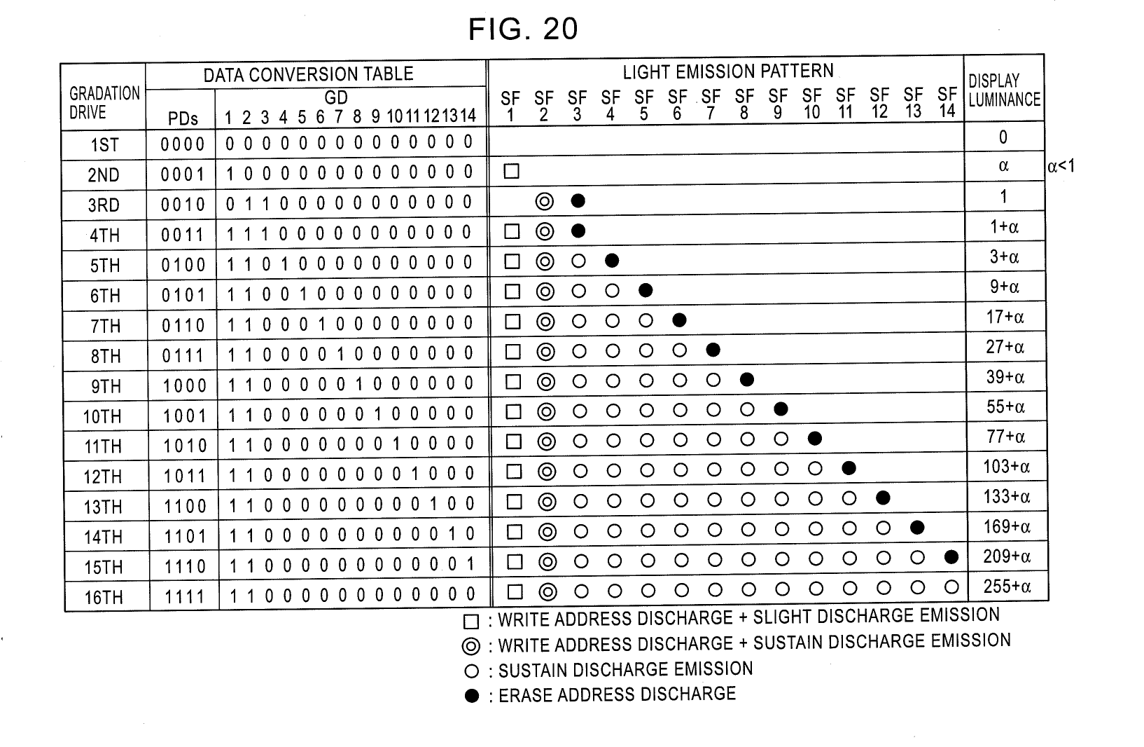

FIG. 19 shows a light-emission drive sequence employing a selective erase address scheme for driving the PDP 50, in the plasma display apparatus shown in FIG. 1. The drive control circuit 56 supplies various control signals for driving the PDP 50 configured shown in FIG. 1 to the panel driver formed by the X-electrode and Y-electrode drivers 51, 53 and the address driver 55, according to the light-emission drive sequence as shown in FIG. 19. Namely, in the beginning sib-field within such a one-field (one-frame) display duration as shown in FIG. 20, the drive control circuit 56 supplies, to the panel driver, various control signals to sequentially execute the driving according to a first reset stage R1, a first selective write address stage W1_{W} and a slight light-emission stage LL. In the SF2 next to the sub-field SF1, various control signals are supplied to the panel driver, to sequentially execute the driving according to a second reset stage R2, a second selective write address stage W2_{W} and a sustain stage I. In each of sub-fields SF3-SF14, various control signals are supplied to the panel driver, to sequentially execute the driving according to a selective erase address stage W_{D} and a sustain stage I. Incidentally, limitedly to the last sub-field SF14 of the one-field display duration, the drive control circuit 56 after executing the sustain stage I supplies, to the panel driver, various control signals to sequentially execute the driving according to an erase period E.

Meanwhile, the drive control circuit 56 converts the higher-order four bits of the dither-added pixel data, obtained by the dithering, into 4-bit halftoned pixel data PDs to represent light intensity in 16 levels, as shown in FIG. 20. The drive control circuit 56 converts the halftoned pixel data PDs into 14-bit pixel drive data GD according to such a data conversion table as shown in FIG. 20 and associates the first to fourteenth bits respectively with the sub-fields SF1-SF14 thus supplying, as pixel-drive data bit, the bit digit corresponding to the relevant sub-field SF in an amount of one display line (m in the number) to the address driver 55.

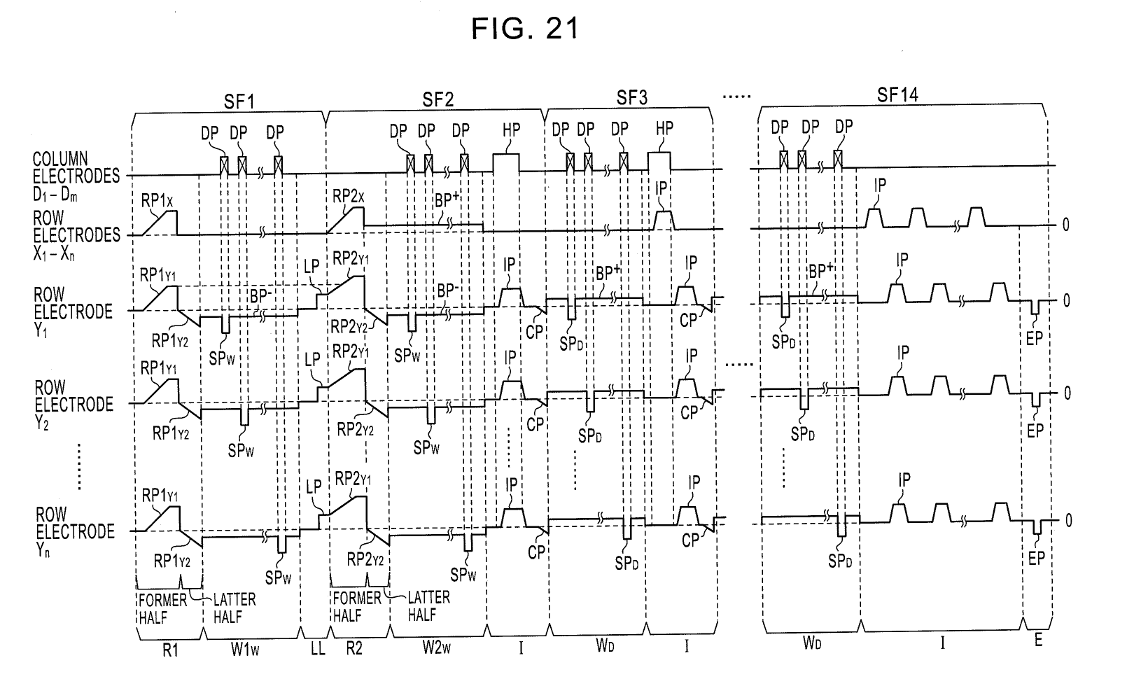

The panel driver, i.e. the X-electrode driver 51, the Y-electrode driver 53 and the address driver 55, generates various drive pulse as shown in FIG. 21 according to the various control signals supplied from the drive control circuit 56 and supplies those to the column and row electrodes D, X and Y of the PDP 50.

FIG. 21 representatively shows only the operations in the SF1-SF3 and the last sub-field SF14 out of the sub-fields SF1-SF14 shown in FIG. 19. Meanwhile, in FIG. 21, like reference characters are attached to the pulses like the various drive pulses to be generated in employing such a selective erase address scheme as shown in FIG. 8.

In the former half of the first reset stage R1 of the sub-field SF1, the Y-electrode driver 53 applies, to all the row electrodes Y₁-Yₙ, a positive reset pulse RP_{Y1} having a waveform moderate at the leading edge with the passage of time as compared to that of the sustain pulse. Note that the reset pulse RP1_{Y1} has a peak potential higher than the peak potential of the sustain pulse, as shown in FIG. 21. In this duration, the address driver 55 sets the column electrodes D₁-Dₘ at the ground potential (0 volt). By the application of the reset pulse RP1_{Y1}, a first reset discharge is caused between the row electrode Y and the column electrode D in every discharge cell PC. Namely, in the former half of the first reset stage R1, a discharge that a current flows from the row electrode Y to the column electrode D (hereinafter, referred to as cathode-at-column discharge) is caused as the first reset discharge by applying a voltage to between respective electrodes such that the row electrode Y serves as an anode and the column electrode D as a cathode. By the first reset discharge, wall charges are formed negative around the row electrode Y and positive around the column electrode D in every discharge cell PC.

Meanwhile, in the former half of the first reset stage R1, the X-electrode driver 51 applies, to all the row electrodes X₁-Xₙ, a reset pulse RP_{X} having the same polarity as the reset pulse RP1_{Y1} and a peak potential capable of preventing the surface discharge as caused between the row electrodes X and Y by the application of the reset pulse RP1_{Y1}.

In the latter half of the first reset stage R1 of the sub-field SF1, the Y-electrode driver 53 generates a reset pulse RP1_{Y2} having pulse waveform having a potential moderately lowering with the passage of time and reaching a negative peal potential as shown FIG. 21, and applies it to all the row electrodes Y₁-Yₙ. On this occasion, a second rest discharge is caused between the row electrodes X and Y in every discharge cell PC in response to the application of the reset pulse RP1_{Y2}. Incidentally, the reset pulse RP1_{Y2} has a peak potential given minimal in positively causing such a second reset discharge between the row electrodes X and Y in consideration of the wall charges formed around the row electrodes X and Y due to the first reset discharge. Meanwhile, the reset pulse RP1_{Y2} has a peak potential set at a potential higher than the peak potential of a negative write scan pulse SP_{W}, referred later, i.e. at a potential approximate to 0 volt. Namely, this is because, in case the peak potential of the reset pulse RP1_{Y2} be provided lower than the peak potential of the write scan pulse SP_{W}, an intense discharge would occur between the row electrode Y and the column electrode D, to greatly erase the wall charges formed around the column electrode D and hence make instable the address discharge to be caused in a first selective write address stage W1_{W}, referred later. By the second reset discharge caused in the latter half of the first reset stage R1, erased away the wall charges formed around the row electrodes X and Y in each discharge cell PC, thus initializing every discharge cell PC into off-mode. Furthermore, by the application of the reset pulse RP1_{Y2}, a weak discharge is caused also between the row electrode Y and the column electrode D in every discharge cell PC. The discharge erases part of the positive wall charges formed around the column electrode D and adjust those into an amount that can correctly cause a selective write address discharge in the first selective write address stage W1_{W}.

In the first selective write address stage W1_{W} of the sub-field SF1, the Y-electrode driver 53 sequentially, selectively applies a write scan pulse SP_{W} having a negative peak potential to the row electrodes Y₁-Yₙ while applying such a base pulse BP⁻ having a negative predetermined peak potential as shown in FIG. 21 simultaneously to the row electrodes Y₁-Yₙ. In this duration, the X-electrode driver 51 applies a 0-V voltage to the row electrodes X₁-Xₙ. Furthermore, in the first selective write address stage W1_{W}, the address driver 55 first generates a pixel data pulse DP dependent upon the logic level of the pixel-drive data bit corresponding to the sub-field SF1. For example, when supplied a pixel-drive data bit having a logic level 1 for setting the discharge cell PC to on-mode, the address driver 55 generates a pixel data pulse DP having a positive peak potential. Meanwhile, it generates a pixel data pulse DP having a low voltage (0 volt) in accordance with a pixel-drive data bit having a logic level 0 for setting the discharge cell PC in off-mode. Then, the address driver 55 applies the pixel data pulse DP in an amount of one display line (m in the number) per time to the column electrodes D₁-Dₘ synchronously with the application timing of each write scan pulse SP_{W}. Simultaneously with the write scan pulse SP_{W}, a selective write address discharge is caused between the column electrode D and the row electrode Y in the discharge cell PC to which applied was a pixel data pulse DP high in voltage for setting in on-mode. By the selective write address discharge, the discharge cell PC is set in a state wall charges are formed positive around the row electrode Y and negative around the column electrode D, i.e. in on-mode. Meanwhile, simultaneously with the write scan pulse SP_{W}, a selective write address discharge as noted above is not caused between the column electrode D and the row electrode Y in the discharge cell PC to which applied was a pixel data pulse DP low in voltage (0 volt) for setting into off-mode. Accordingly, the discharge cell PC remains in the state immediately before, i.e. in off-mode initialized in the reset stage R.

In the slight light-emission stage LL of the sub-field SF1, the Y-electrode driver 53 applies, simultaneously to the row electrodes Y₁-Yₙ, a slight light-emission pulse LP having such a positive predetermined peak potential as shown in FIG. 21. By the application of the slight light-emission pulse LP, a discharge (hereinafter, referred to as a slight emission discharge) is caused between the column electrode D and the row electrode Y in the discharge cell PC being set in on-mode. Namely, in the slight light-emission stage LL, a slight emission discharge is caused only between the column electrode D and the row electrode in the discharge cell PC being set in on-mode by applying, to the row electrode Y, such a voltage as not to cause a discharge between the row electrodes X and Y despite to cause a discharge between the row electrode Y and the column electrode D in the discharge cell PC. In this case, the slight light-emission pulse LP has a peak potential lower than the peak potential of the sustain pulse IP to be applied in the sustain stage I in the sub-field SF2 and the subsequent, referred later. For example, it is equal to the potential to the row electrode Y be applied in a selective erase address stage WD, referred later. Meanwhile, as shown in FIG. 21, the slight light-emission pulse LP has a change rate, in the potential rise period with the passage of time, higher than the change rate of the reset pulse (RP1_{Y1}, RP2_{Y1}) in the potential rise period with the passage of time. Namely, by providing the slight light-emission pulse LP with a potential change sharper at its leading edge than the potential change of the reset pulse at its leading edge, a discharge is caused more intensely than the first reset discharge to be caused in the first reset stage R1. Here, because such a discharge is a cathode-at-column discharge as noted before that is caused by a slight light-emission pulse LP lower in peak potential than the sustain pulse IP, the light-emission intensity due to discharge is lower than that of a sustain discharge (referred later) caused between the row electrodes X and Y. Namely, in the slight light-emission stage LL, caused as a slight emission discharge is a discharge low in intensity level than a sustain discharge, i.e. a discharge for emitting slight light in a degree to be used in display, though it is a discharge for emitting light higher in intensity level than a first reset discharge. In this case, a selective write address discharge is caused between the column electrode D and the row electrode Y in the discharge cell PC, in a first selective write address stage W1_{W} to be executed immediately preceding the slight light-emission stage LL. Consequently, in the sub-field SF1, representation is available at a light intensity in a level one higher than a light-intensity level 0.

After the slight emission discharge, wall charges are formed negative around the row electrode Y and positive around the column electrode D.

In the former half of the second reset stage R2 of the sub-field SF2, the Y-electrode driver 53 applies, to all the row electrodes Y₁-Yₙ, a positive reset pulse RP2_{Y1} having a waveform moderate in potential change at the leading edge with the passage of time as compared to that of the sustain pulse, referred later. Note that the reset pulse RP1_{Y1} has a peak potential higher than the peak potential of the reset pulse RP1_{Y1}. In this duration, the address driver 55 set the column electrodes D₁-Dₘ at the ground potential (0 volt) while the X-electrode driver 51 applies, to all the row electrodes X₁-Xₙ, a positive reset pulse RP2_{X} having a peak potential capable of preventing the surface discharge as caused between the row electrodes X and Y by the application of the reset pulse RP2_{Y1}. Incidentally, provided that no surface discharges are caused between the row electrodes X and Y, the X-electrode driver 51 may sets all the row electrode X₁-Xₙ at the ground potential (0 volt) instead of the application of the reset pulse RP2_{X}. A first reset discharge is caused weaker than the cathode-at-column discharge caused in the slight light-emission stage LL, between the row electrode Y and the column electrode D in the discharge cell where no cathode-at-column discharges were caused in the slight light-emission stage LL out of the discharge cells PCs. Namely, in the former half of the second reset stage R2, caused as the first reset discharge is a cathode-at-column discharge for flowing a current from the row electrode Y toward the column electrode D, by applying a voltage to between respective electrodes such that the row electrode Y serves as an anode and the column electrode D as a cathode. Meanwhile, in the discharge cell PC where the slight emission discharge was already caused in the slight light-emission stage LL, no discharges are caused even if the reset pulse RP2_{Y1} is applied. Consequently, after terminating the former half of the second reset stage R2, wall charges are formed negative around the row electrode Y and positive around the column electrode D in every discharge cell PC.

In the latter half of the second reset stage R2 of the sub-field SF2, the Y-electrode driver 53 applies, to the row electrodes Y₁-Yₙ, a reset pulse RP2_{Y2} having a pulse waveform having a potential moderately lowering with the passage of time and reaching a negative peak potential as shown in FIG. 21. Furthermore, in the latter half of the second reset stage R2, the X-electrode driver 51 applies, to the row electrodes X₁-Xₙ, a base pulse BP⁺ having a positive peak potential, over the duration the reset pulse RP2Y2 is being applied to the row electrode Y. By the application of the negative reset pulse RP2_{Y2} and the positive base pulse BP⁺, a second reset discharge is caused between the row electrodes X and Y in every discharge cell PC. By the second reset discharge, erased away is the major part of the wall charges formed around the row electrodes X and Y in every cell PC. This initializes all the discharge cells into off-mode. Furthermore, by the application of the reset pulse RP2_{Y2}, a weak discharge is caused between the row electrode Y and the column electrode D in every cell PC, to erase away part of the positive wall charges formed around the column electrode D. This adjusts the wall charges remaining nearby the column electrode D in every cell PC, to an amount that can correctly cause a selective write address discharge in the second selective write address stage W2_{W}.

Incidentally, the application voltage of the reset and base pulses RP2_{Y2}, BP⁺ between the row electrodes X and Y is given as a value to positively cause a second reset discharge between the row electrodes X and Y, in consideration of the wall charges formed around the row electrodes X and Y by the first reset discharge. Meanwhile, the negative peak potential of the reset pulse RP2_{Y2} is set higher than the negative peak potential of a write scan pulse SP_{W} referred later, i.e. approximately to 0 volt. Namely, if the peak potential of the reset pulse RP2_{Y2} be provided lower than the peak potential of the write scan pulse SP_{W}, an intense discharge is caused between the row electrode Y and the column electrode D, to greatly erase the wall charges formed around the column electrode D and hence make instable the address discharge in the second selective write address stage W2_{W}.

In the second selective write address stage W2_{W} of the sub-field SF2, the Y-electrode driver 53 sequentially, selectively applies a write scan pulse SP_{W} having a negative peak potential to the row electrodes Y₁-Yₙ while applying such a base pulse BP− having a negative predetermined peak potential as shown in FIG. 21 simultaneously to the row electrodes Y₁-Yₙ. In this duration, the X-electrode driver 51 continues applying a base pulse BP⁺ having a positive peak potential to the row electrodes X₁-Xₙ. The application voltage of the base pulses BP⁺ and BP⁻ to between the row electrodes X and Y is lower than the discharge start voltage for the discharge cell PC. In the second selective write address stage W2_{W}, the address driver 55 first generates a pixel data pulse DP having a peak potential commensurate with the logic level of the pixel-drive data bit corresponding to the sub-field SF2. For example, when supplied a pixel-drive data bit having a logic level 1 for setting the discharge cell PC into on-mode, the address driver 55 generates a pixel data pulse DP having a positive peak potential. Meanwhile, it generates a pixel data pulse DP low in voltage (0 volt) in accordance with the pixel-drive data bit having a logic level 0 for setting the discharge cell PC to off-mode. The address driver 55 applies the pixel data pulse DP in an amount of one display line per time (m in the number) to the column electrodes D₁-Dₘ synchronously with the application timing of each write scan pulse SP_{W}. In this case, simultaneously with the write scan pulse SP_{W}, a selective write address discharge is caused between the column electrode D and the row electrode Y in the discharge cell PC to which has been applied the pixel data pulse DP high in voltage for setting to an on-mode. Furthermore, immediately after the selective write address discharge, a weak discharge is caused also between the row electrodes X and Y in the relevant discharge cell PC. Namely, after the application of the write scan pulse SP_{W}, a voltage is applied to between the row electrodes X and Y in an amount commensurate with the base pulses BP⁻, BP⁺. However, because this voltage is set at a voltage lower than the discharge start voltage for the discharge cells PCs, no discharge is caused within the discharge cell PC only by the application of the voltage. However, if a selective write address discharge is caused, a discharge is caused between the row electrodes X and Y only with the voltage application of the base pulses BP⁻, BP⁺ due to the inducement of the selective write address discharge. By the discharge and the selective write address discharge, the discharge cell PC is set with wall charges positively around the row electrode Y, negatively around the row electrode X and negatively around the column electrode D, i.e. set in on-mode. Meanwhile, simultaneously with the write scan pulse SP_{W}, a selective write address discharge as in the foregoing is not caused between the column electrode D and the row electrode Y in the discharge cell PC to which has been applied the pixel data pulse DP low in voltage (0 volt) for setting to an off-mode. Thus, no discharge occurs between the row electrodes X and Y. Therefore, the relevant discharge cell PC remains in the state as it is, i.e. in off-mode initialized in the second reset stage R2.

In the sustain stage I of the sub-field SF2, the Y-electrode driver 53 generates a sustain pulse IP having a positive peak potential in an amount of one pulse and applies it simultaneously to the row electrodes Y₁-Yₙ. In this duration, the X-electrode driver 53 sets the row electrodes X₁-Xₙ at the ground potential (0 volt). In the sustain stage I of the sub-field SF2, the address driver 55 generates an auxiliary pulse HP having a pulse waveform for maintaining a positive peak potential over the period between the leading edge and the peak potential point of the sustain pulse IP and applies it to the column electrodes D₁-Dₘ. Incidentally, the peak potential of the auxiliary pulse HP is equal to the peak potential of the pixel data pulse.

In the sustain stage I of the sub-field SF2, a sustain discharge is caused between the row electrodes X and Y in the discharge cell PC staying in on-mode, by the application of sustain and auxiliary pulses IP, HP. By illuminating the light from the phosphor layer 17 to the external through the front transparent substrate 10 due to the sustain discharge, light emission is effected for display correspondingly to the intensity weight for the sub-field SF1. In response to the application of the sustain pulse IP, a discharge is also caused between the row electrode Y and the column electrode D in the discharge cell PC staying in on-mode. By the discharge and the sustain discharge, wall charges are formed negative around the row electrode Y and positive around the row and column electrodes X, D in the discharge cell PC.

After the application of the sustain pulse IP, the Y-electrode driver 53 applies a wall-charge adjusting pulse CP having a negative peak potential moderate in potential change at the leading edge with the passage of time as shown in FIG. 21, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In the selective erase address stage W₀ of each of the sub-fields SF3-SF14, the Y-driver 53 sequentially, selectively applies such an erase scan pulse SP_{D} having a negative peak potential as shown in FIG. 21 to the row electrode Y₁-Yₙ while applying a base pulse BP⁺ having a positive predetermined peak potential to the row electrodes Y₁-Yₙ. The base pulse BP⁺ is set at a potential that can prevent against an erroneous discharge between the row electrodes X and Y over the execution period of the selective erase address stage W₀. Over the execution period of the selective erase address stage W₀, the X-electrode driver 51 sets the row electrodes X₁-Xₙ at the ground potential (0 volt). In the selective erase address stage W_{D}, the address driver 55 first converts the pixel-drive data bit corresponding to the relevant sub-field SF into a pixel data pulse DP having a pulse voltage suited for the logic level thereof. For example, when supplied a pixel-drive data bit having a logic level 1 for changing the discharge cell PC from off-mode to on-mode, the address driver 55 converts it into a pixel data pulse DP having a positive peak potential. Meanwhile, when supplied a pixel-drive data bit having a logic level 0 for maintaining the current state of the discharge cell PC, it is converted into a pixel data pulse DP having a low voltage (0 voltage). The address driver 55 applies the pixel data pulse DP in an amount of one display line (m in the number) per time to the column electrodes D₁-Dₘ synchronously with the application timing of each erase scan pulse SP_{D}. In this case, simultaneously with the write scan pulse SP_{W}, a selective write address discharge is caused between the column electrode D and the row electrode Y in the discharge cell PC to which has been applied the pixel data pulse DP high in voltage and positive in polarity. By the selective erase address discharge, the discharge cell PC is set in a state that wall charges are formed positive around the row electrodes X and Y and negative around the column electrode D, i.e. in off-mode. Meanwhile, simultaneously with the erase scan pulse SP_{D}, a selective erase address discharge as noted above is not caused between the column electrode D and the row electrode Y in the discharge cell PC to which applied was a pixel data pulse DP low in voltage (0 volt). Accordingly, the discharge cell PC remains in the state as it is (on or off-mode).

In the sustain stage I of each of the sub-fields SF3-SF14, the X-electrode and Y-electrode drivers 51, 53 apply sustain pulses IP each having a positive peak potential alternately to the row electrodes X and Y as shown in FIG. 21, repeatedly in the number of times corresponding to the intensity weight for the sub-field (even number of times). Incidentally, in the sustain stage I of the SF immediately succeeding the SF having an intensity weight smaller than a predetermined value out of the sub-fields SF3-SF14, the address driver 55 generates a positive auxiliary pulse HP nearly simultaneously with the first-applied sustain pulse IP and applies it to the column electrodes D₁-Dₘ. For example, the address driver 55 applies to the column electrode D an auxiliary pulse HP for maintaining a positive peak potential over the period between the sustain pulse IP leading edge and the peak potential point of the sustain pulse IP first applied as shown in FIG. 21, in the sustain stage I of the SF immediately succeeding the SF to which the application count of the sustain pulse is assigned as 10 or smaller (SF3 in FIG. 21). Note that the peak potential of the auxiliary pulse HP is equal to the peak potential of the pixel data pulse.

In the sustain stage I of each of the sub-fields SF3-SF14, a sustain discharge is caused between the row electrodes X and Y in the discharge cell PC being set in on-mode each time the sustain pulse IP is applied as shown in FIG. 21. On this occasion, by illuminating the light from the phosphor layer 17 to the outside through the front transparent substrate 10 due to the sustain discharge, light emission is effected for display in the number of times corresponding to the intensity weight for the relevant sub-field SF.

In the sustain stage I of each of the sub-fields SF3-SF14, wall charges are formed negative around the row electrode Y and positive around the row electrode X and column electrode D in the discharge cell PC where a sustain discharge was caused by the last sustain pulse IP. After the application of the sustain pulse IP, the Y-electrode driver 53 applies a wall-charge adjusting pulse CP having a negative peak potential moderate in potential change at the leading edge with the passage of time as shown in FIG. 21, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In the last end of the last sub-field SF14, the Y-electrode driver 53 applies an erase pulse EP having a negative peak potential to all the row electrodes Y₁-Yₙ. By the application of the erase pulse EP, an erase discharge is caused only in the discharge cell PC staying in on-mode. By the erase discharge, the discharge cell PC staying in on-mode transits into off-mode.

The driving like the above is implemented based on such 16 patterns of pixel drive data GD as shown in FIG. 20.

In the outset, for the second intensity level representing a light intensity one level higher than the first intensity level representing black (intensity level 0), a selective write address discharge is caused for setting the discharge cell PC to on-mode only in the SF1 out of the sub-fields SF1-SF14 as shown in FIG. 20, to cause a slight emission discharge at the discharge cell PC set in the on-mode (indicated with an open square). In this case, the intensity level upon light emission caused by the selective write address discharge and slight emission discharge is lower than the light-intensity level upon light emission caused by once sustain discharge. Consequently, provided that the intensity level visually perceived due to a sustain discharge is taken “1”, the representation in the second intensity level is at an intensity corresponding to an intensity level “a” lower than the intensity level “1”.

In the third intensity level representing a light intensity one level higher than the second intensity level, a selective write address discharge is caused (indicated with a double circle) for setting the discharge cell PC to on-mode only in the SF2 out of the sub-fields SF1-SF14, to cause a selective erase address discharge (indicated with a black circle) for changing the discharge cell PC to off-mode in the next sub-field SF3. Consequently, in the third intensity level, light emission is caused by once sustain discharge only in the sustain stage I of the SF2 out of the sub-fields SF1-SF14, thus making a representation at a light intensity corresponding to the intensity level “1”.

In the fourth intensity level representing a light intensity one level higher than the third intensity level, a selective write address discharge is first caused for setting the discharge cell PC in on-mode in the sub-field SF1, to cause a slight emission discharge at the discharge cell PC set in the on-mode (indicated with an open square). In the fourth intensity level, a selective write address discharge is caused (indicated with a double circle) for setting the discharge cell PC to on-mode only in the SF2 out of the sub-fields SF1-SF14, to cause a selective erase address discharge (indicated with a black circle) for changing the discharge cell PC to off-mode in the next sub-field SF3. Consequently, in the fourth intensity level, light emission is caused at a light intensity level “a” in the sub-field SF1, followed by executing once a sustain discharge with light emission at a light intensity level “1”. This allows for expression at a light intensity corresponding to a level of “a”+“1”.

In each of the fifth to sixteenth intensity levels, a selective write address discharge is caused for setting the discharge cell PC to on-mode in the sub-field SF1, to cause a slight emission discharge in the discharge cell PC set in the on-mode (indicated with an open square). In only one sub-field corresponding to that intensity level, a selective erase address discharge is caused for changing the discharge cell PC to off-mode (indicated with a black circle). Accordingly, in each of the fifth to sixteenth intensity levels, a slight emission discharge is caused in the sub-field SF1 and then a sustain discharge is once caused in the SF2. Thereafter, in each of the sub-fields continuing in the number corresponding to the intensity level (indicated with open circles), sustain discharges are caused in the number of times assigned to the relevant sub-field. Due to this, in each of the fifth to sixteenth intensity levels, visual perception is available at a light intensity corresponding to a level of “a”+“total number of sustain discharges caused in the one-field (one-frame) display duration”. Therefore, with the driving shown in FIGS. 19 to 21, the light intensity in a level range of from “0” to “255+a” can be expressed with 16 levels as shown in FIG. 20.

In this case, in the driving shown in FIGS. 19 to 21, a slight emission discharge is caused as a discharge contributing to a display image in the sub-field SF1 smallest in intensity weight, instead of a sustain discharge. Such a slight emission discharge is to occur between the column electrode D and the row electrode Y, and hence is lower in intensity level upon light emission due to discharge as compared to a sustain discharge occurring between the row electrodes X and Y. In the case of making a representation at a light intensity (second intensity level) one level higher than black display (intensity level 0) by means of such a slight emission discharge, the difference of light intensity is smaller from the intensity level 0 as compared to the case of representing same by means of a sustain discharge. Accordingly, the capability of intensity-level representation is enhance upon representing an image having a low light intensity. In the second intensity level, because no reset discharge is caused in the second reset stage R2 of the SF2 next to the sub-field SF1, dark contrast is suppressed from lowering due to such a reset discharge. Incidentally, in the driving with light-emission patterns shown in FIG. 20, a slight emission discharge is caused with a light emission at an intensity level a in the sub-field SF1, also for each of the fourth intensity level and the subsequent. However, such a slight emission discharge may be not caused in a third intensity level or the subsequent. In brief, the light emission based on a slight emission discharge is extremely low in intensity (at an intensity level a). For this reason, the light-intensity increase by a level a is possibly not visually perceived in the fourth intensity level or the subsequent that a sustain discharge with light emission higher in light intensity than that. In such a case, there is no significance in causing a slight emission discharge.

Here, in the driving shown in FIG. 21, a cathode-at-column discharge is caused, as a first reset discharge, flowing a current from the row electrode Y to the column electrode D by applying voltage to respective electrodes such that the column electrode D serves as a cathode and the row electrode Y as an anode, in the first reset stage R1 of the beginning sub-field SF1. Accordingly, in the first reset discharge, the anode ions in the discharge gas when traveling toward the column electrode D go into bombardment against the MgO crystal provided as an electron emission material contained in the phosphor layer 17 as shown in FIG. 5, thus causing secondary electrons to emit from the MgO crystal. Particularly, in the PDP 50, the probability of collision with an anode ion is raised by exposing the MgO crystal in the discharge space as shown in FIG. 5, thus allowing secondary electrons to emit into the discharge space. Because this lowers the discharge start voltage of the discharge cell PC through the priming action of such secondary electrons, a reset discharge can be caused comparatively weak. Therefore, display is available with improved dark contrast owing to the lowered light intensity of a reset discharge weakened.

Meanwhile, in the driving shown in FIG. 21, a reset discharge is caused between the row electrode Y formed closer to the front transparent substrate 10 shown in FIG. 3 and the column electrodes D formed closer to the back substrate 14. This accordingly can further improve the dark contrast because of the reduced discharge light released to the outside through the front transparent substrate 10 as compared to the case of causing a reset discharge between the row electrodes X and Y both formed closer to the front transparent substrate 10.

Meanwhile, in the PDP 50 serving as a plasma display panel, CL-emission MgO crystals are contained as secondary electron emission materials not only in the magnesium oxide layer 13 formed closer to the front transparent substrate 10 in each discharge cell PC but also in the phosphor layer 17 formed closer to the back substrate 14 as shown in FIG. 5.

This accordingly makes it possible to cease the weak discharge in a short time as compared to the cathode-at-column discharge (shown in FIG. 9) in the discharge cell containing a CL-emission MgO crystal only in the magnesium oxide layer 13 (shown in FIG. 10). Accordingly, because a cathode-at-column discharge extremely weak in discharge intensity can be caused as a reset discharge, the dark contrast, particularly dark contrast upon displaying a dark image, can be raised.

Meanwhile, in the driving shown in FIG. 21, by applying only once a sustain pulse IP in the sustain stage I of the sub-field SF2, the number of times of sustain discharges is reduced to only once thus enhancing the display reproducibility for an image of low luminance. Incidentally, after ceasing of the sustain discharge caused in accordance with the sustain pulse IP in one time, wall charges are formed negative around the row electrode Y and positive around the column electrode D. This makes it possible to cause a cathode-at-column discharge as a selective erase address discharge in the selective erase address stage W_{D} of the sub-field SF3. In this case, in the driving shown in FIG. 21, the sustain pulse IP is applied in an even number of times in the sustain stage I of each of the sub-fields SF3-SF14. Accordingly, because wall charges are formed negative around the row electrode Y and positive around the column electrode D immediately after the completion of the sustain stage I, anode-at-column discharge is available in the selective erase address stage W_{D} to be executed following the sustain stage I. Consequently, the application to the column electrode D is only by positive pulses, thus preventing the cost increase of the address driver 55.

In the driving shown in FIG. 21, an auxiliary pulse HP is applied once to all the column electrodes D nearly simultaneously with the sustain pulse IP first applied, only once in the beginning of the sustain stage I of the SF immediately succeeding the SF small in intensity weight out of the sub-fields SFs.

Namely, the address driver 55 applies an auxiliary pulse HP to all the column electrodes D, in timing as shown in FIG. 11A for example. Namely, the auxiliary pulse HP is started applied to all the column electrodes D at time t2 immediately before applying the sustain pulse IP. In this case, the auxiliary pulse HP is maintained in its positive peak state over the duration of a predetermined marginal period TP, a sustain-pulse IP leading edge period T1 and a peak potential period T2, from the time t2. Incidentally, the leading edge period T1 is a duration that the potential of the sustain pulse IP moderately increases with the passage of time from the 0-volt state at the time t3 and reaches the peak potential VP. Meanwhile, the peak potential period T2 is a duration that the sustain pulse IP is maintained at the peak potential VP. Namely, the auxiliary pulse HP is maintained at its positive peak potential over the duration from the time t2, earlier by a predetermined marginal period TP than the time t3 as a start time of the leading edge period T1 of the sustain pulse IP, over to a termination time of the peak potential period T2 of the sustain pulse IP.

Here, in case the sustain pulse IP is applied to the row electrode (X or Y) and the auxiliary pulse HP is to the column electrode D, a first round of discharge (dc1) is first caused between the row electrodes X and Y in the discharge cell PC staying in on-mode, at time t4 in the leading edge period T1 of the sustain pulse IP. At this time, the potential of the sustain pulse IP is temporarily lowered as shown in FIG. 1, by the current flowing between the row electrodes X and Y caused due to the discharge dc1. However, at the later time t5, because the potential on the row electrode (X, Y) is clamped by the peak potential of the sustain pulse IP, the potential of the sustain pulse IP again rises toward the peak potential VP. Thereafter, when the potential of the sustain pulse IP reaches the peak potential VP at such time t1 as shown in FIG. 11, a second round of discharge (dc2) is caused between the row electrodes X and Y in the discharge cell PC staying in the on-mode.

In this manner, if the auxiliary pulse HP is applied together with the sustain pulse IP, a first round of discharge is first caused in the period of the leading edge of the sustain pulse IP, followed by the occurrence of a second round of discharge at the time the potential of the sustain pulse IP reaches its peak potential.

The operational effect to be enjoyed upon implementing such driving as shown in FIG. 11 is described in the following.

In case a sustain pulse IP having a positive peak potential is applied to the row electrode Y (or X), electric field occurs between the row electrodes X and Y and between the row electrode Y (or X) and the column electrode D. However, in this duration, when applying to the column electrode D an auxiliary pulse HP having a peak potential same in polarity as the peak potential of the sustain pulse IP, electric field is weakened between the row electrode Y (or X) and the column electrode D. Thereupon, electric field is intensified between the row electrodes X and Y in an amount corresponding to the weakening of the electric field between the row electrode Y (or X) and the column electrode D, thus resulting in a tendency toward readily causing a discharge between the row electrodes X and Y.

Accordingly, even where a discharge delay occurs due to the reduced charged grains remaining within the discharge cell PC in a stage immediately before, twice discharges (dc1, dc2) can be successively caused as sustain discharges as shown in FIG. 11 without increasing the leading edge period T1 to a required degree or greater. In this case, twice discharges cause an illumination of display light with the intensity nearly uniform in level throughout all the discharge cells, thus eliminating brightness irregularity.

Incidentally, such successive twice discharges (dc1, dc2) as shown in FIG. 11 is satisfactorily caused by the application of an auxiliary pulse HP, the address driver 55 may apply an auxiliary pulse HP to all the column electrode D in such timing as shown in FIG. 11B in place of that in FIG. 11A. Namely, it is satisfactory to apply an auxiliary pulse HP that maintains a positive peal potential state over the duration including the time t4 that a first round of discharge (dc1) is caused and the time t1 the peal potential of the sustain pulse is reached in the leading edge period T1, at or later than a start time t3 of the leading edge period T1 of the sustain pulse IP.

In the meanwhile, there arises a problem of increased consumption power in case all the sustain discharges are provided with such twice discharges (dc1, dc2) as shown in FIG. 11 by the application of an auxiliary pulse HP simultaneously with every sustain pulse IP to be applied in the one-frame display period.

In order to reduce the power consumption, an auxiliary pulse HP is applied simultaneously with the sustain pulse IP only at the time the delay of discharge is conspicuous. Here, the time the delay of discharge is conspicuous, i.e. the time the charged grains formed in the discharge cell PC are reduced in amount by a sustain discharge, is at (a) the execution of a sustain stage in the beginning sub-field, (b) the extreme beginning of a sustain stage of each of the sub-field, and (c) the execution of a sustain stage in the sub-field immediately succeeding the sub-field to which sustain pulses are assigned comparatively less in the number.

In the driving shown in FIG. 21, an auxiliary pulse HP is applied simultaneously with a sustain pulse IP only in the extreme beginning of the sustain stage of a sub-field immediately succeeding the sub-field to which sustain pulses are assigned in the predetermined number of times or smaller (at time the first sustain pulse IP is applied).

Accordingly, the driving shown in FIG. 21 makes it possible to eliminate brightness irregularity in displaying an image of low luminance without the increase of power consumption.

Such an auxiliary pulse HP may be applied at the extreme beginning of the sustain stage of every sub-field within the one-frame display period. Otherwise, auxiliary pulses HP may be applied simultaneously with the sustain pulses IP to be repeatedly applied in each sustain stage of the sub-field immediately succeeding the sub-field to which sustain pulses are assigned in a predetermined number of times.

Waveform control may be done together with the application of an auxiliary pulse HP, as in the following manner in order to eliminate brightness irregularity.

Namely, where sustain discharges are caused simultaneously in a number of discharges cells PCs in the sustain stage I, discharges at the respective cells causes a great amount of current that instantaneously flows through the row electrode (X, Y), which possibly causes a deformation in the sustain pulse waveform. Thus, there arises a problem that the sustain pulse applied for sustain discharge is given not constant between the discharge cells, raising a problem that brightness irregularity is visually perceived because the light intensity of discharge is not uniform in level.

In order to avoid this, an auxiliary pulse HP is applied in such timing as shown in FIG. 11 relatively to the sustain pulse IP to be applied in the extreme beginning of the sustain stage. Moreover, the leading edge period T1 of the sustain pulse IP is changed in length depending upon the number of discharge cells being set in on-mode out of the discharge cells PC_{1,1}-PC_{n,m}.

Namely, the drive control circuit 56 first counts, on each sub-field, the total number of the discharge cells PCs to set to on-mode in the relevant sub-field depending upon such pixel drive data GD as shown in FIG. 20. Then, the drive control circuit 56 controls the X-electrode and Y-electrode drivers 51, 53 to increase such leading edge period T1 of the sustain pulse IP as shown in FIG. 11 with the increase in the total number of the discharge cells PCs staying in the on-mode. Under such control, the leading edge period T1 of the sustain pulse IP, i.e. the time required in reaching the peak potential VP from the 0-volt state, increases with an increase in the total number of the discharge cells PCs. Here, because there are variations in discharge start voltage between the cells resulting from the variations caused in the manufacture, the timing of discharge differs between the discharge cells as the leading edge period T1 of the sustain pulse IP increases. This reduces the amount of the current instantaneously flowing through the row electrode (X, Y) upon each discharge, to suppress the waveform distortion in the sustain pulse. This results in an elimination of brightness irregularity.

Meanwhile, although the reset pulse RP1_{Y1} (RP2_{Y1}) has a potential change rate (inclination) at the leading edge with the passage of time in the embodiment shown in FIG. 21, its waveform may have an inclination gradually changing with the passage of time as shown in FIG. 12 for example.

Although reset discharges are caused simultaneously at all the pixel cells in the first and second reset stages R1 and R2 shown in FIG. 21, reset discharges may be caused differently in time on a block-by-block basis wherein each block is formed by a plurality of pixel cells.

Although a first reset discharge is caused as a cathode-at-column discharge by applying a reset pulse RP1_{Y1} to the row electrodes Y₁-Yₙ in the former half of the first reset stage R1 shown in FIG. 21, it may be omitted.

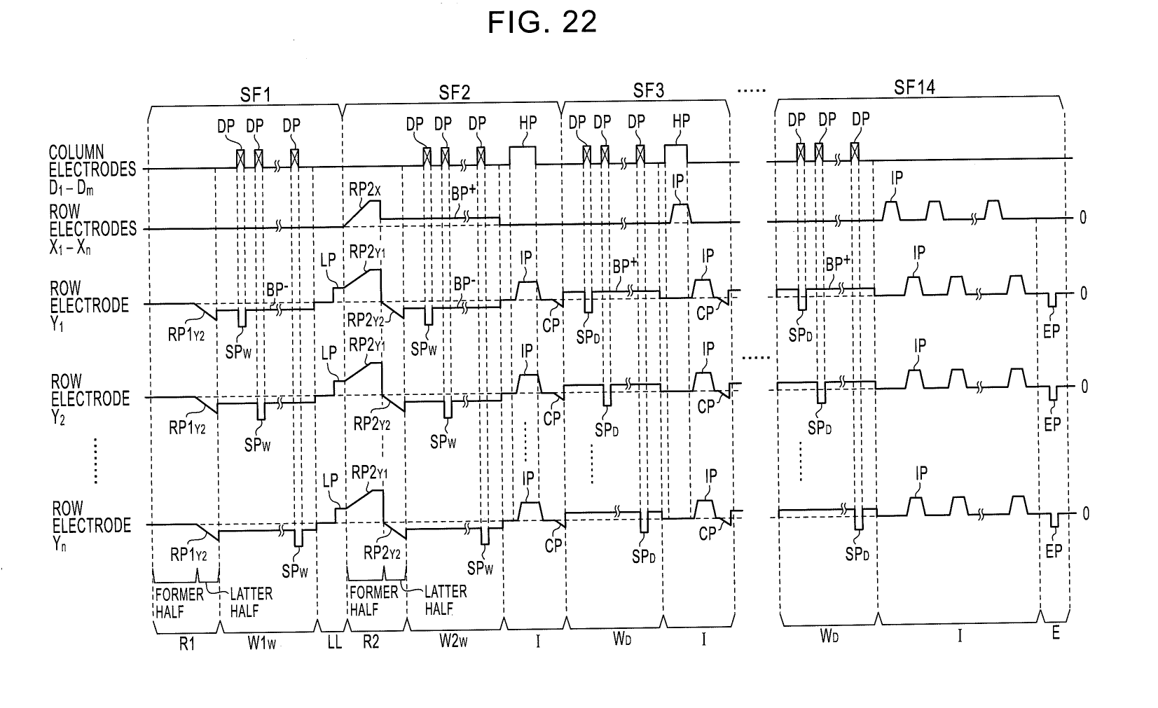

For example, the row electrodes Y₁-Yₙ are fixed at the ground potential in the former half of the first reset stage R1, as shown in FIG. 22.

Namely, the cathode-at-column discharge, caused from the row electrode Y to the column electrode D in the former half of the first reset stage R1, aims at emitting charged grains to stabilize the write discharge in the first selective write address stage W1_{W}. However, where employing a structure containing an MgO crystal including a CL-emission MgO crystal as show in FIG. 5 or 18 for example, write discharge is stabilized as compared to the case not employing such a structure. Accordingly, in the former half of the first reset stage R1, it is possible to employ a structure not to cause a cathode-at column discharge by providing a ground potential to both the row electrode Y and the column electrode D. In this case, the row electrode X is also provided at the ground potential in level as shown in FIG. 22. In also this case, all the discharge cells are placed in off-mode after completing the first reset stage R1 by the discharges due to an erase pulse EP and the discharge due to the application of the reset pulse RP1_{Y2} in the erase stage E of the field immediately preceding. In this case, as for the cathode-at-column discharge due to the application of the reset pulse RP2_{Y1} in the former half of the second reset stage R2 shown in FIG. 22, the charged grains emitted by the reset discharge mainly act to stabilize the write discharge in the second selective write address stage W2_{W}. Accordingly, if the cathode-at-column discharge due to the application of a reset pulse RP2_{Y1} be omitted in the former half of the second reset stage R2, sustain discharges cannot be caused in every sub-field of SF2 and the subsequent. For this reason, it is preferable to execute a cathode-at-column discharge by applying a reset pulse RP2_{Y1} in the former half of the second reset stage R2.

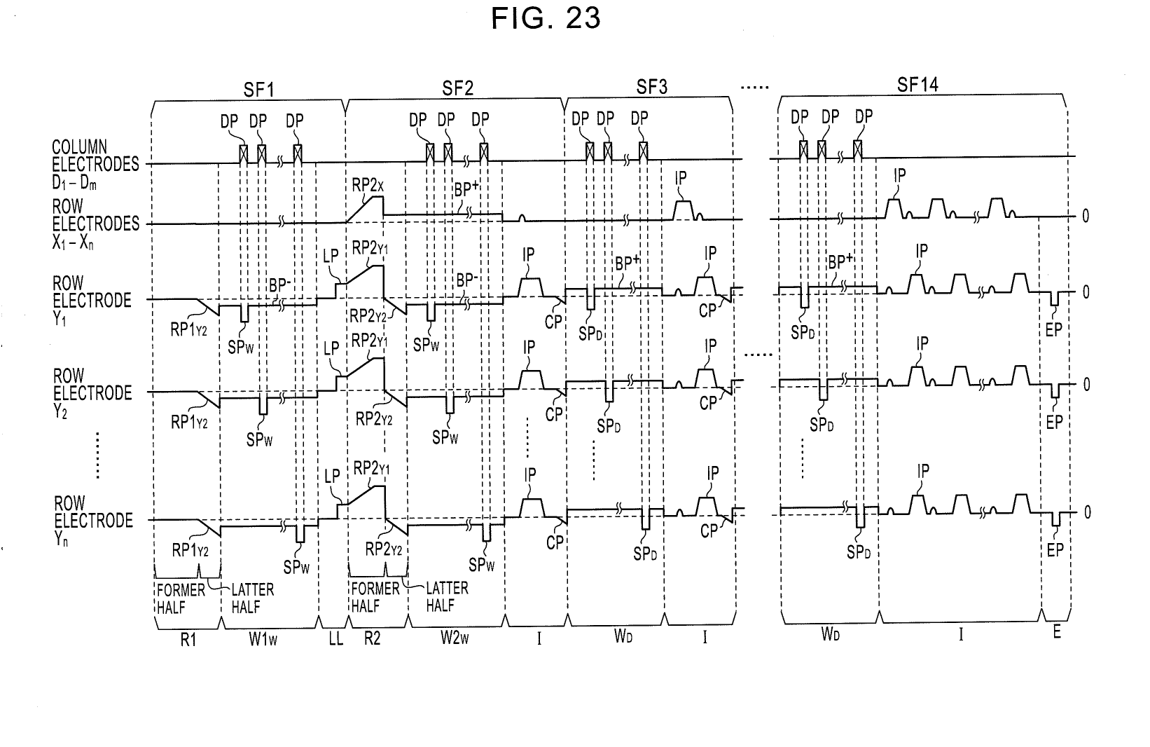

FIG. 23 shows another light-emission drive sequence which is different from sequence of FIG. 19, and which is the light-emission drive sequence employing the selective erase address scheme for driving the PDP 50, in the plasma display apparatus shown in FIG. 1.

In FIG. 23, there are representatively shown only the operations in the sub-fields SF1-SF3 and last sub-field SF14, out of the sub-fields SF1-SF14 shown in FIG. 19.

The applications of drive pulses in FIG. 21 are true for those in all the periods of the sub-field SF1, in the second reset stage R2 and second selective write address stage W2_{W} of the sub-field SF2, in the selective erase address stage W0 of each of the sub-fields SF3-SF14 and in the erase period E of the sub-field SF14.

In the sustain stage I of the sub-field SF2, the Y-electrode driver 53 generates a sustain pulse IP having a positive peak potential, in one-pulse amount, and applies it simultaneously to the row electrodes Y₁-Yₙ. The X-electrode driver 51 places the row electrodes X₁-Xₙ in the floating state in the rise period of the sustain pulse IP to be applied to the row electrodes Y₁-Yₙ as shown in FIG. 16, and sets the row electrodes X₁-Xₙ at the ground potential (0 volt) in the following, remaining duration of sustain pulse IP application. The potential on each of the row electrodes X₁-Xₙ placed in a floating state rises following the potential rise on each of the row electrodes Y₁-Yₙ in the floating state as shown in FIG. 16. When the potential on each of the electrodes Y₁-Yₙ is clamed by the potential Vs, the relevant potential gradually lowers and reaches the ground potential.

In the sustain stage I of the sub-field SF2, a sustain discharge is caused between the row electrodes X and Y in the discharge cell PC staying in on-mode by the application of the sustain pulse IP. By the sustain discharge, light is illuminated from the phosphor layer 17 to the external through the front transparent substrate 10, thus effecting light emission for display correspondingly to the intensity weight for the sub-field SF1. In response to the application of the sustain pulse IP, a discharge is also caused between the row electrode Y and the column electrode D in the discharge cell PC staying in on-mode. By the discharge and the sustain discharge, wall charges are formed negative around the row electrode Y and positive around the row and column electrodes X, D in the discharge cell PC.

After the application of the sustain pulse IP, the Y-electrode driver 53 applies a wall-charge adjusting pulse CP having a negative peak potential moderate in potential change at the leading edge with the passage of time as shown in FIG. 23, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In the sustain stage I of each of the sub-fields SF3-SF14, the X-electrode and Y-electrode drivers 51, 53 apply sustain pulses IP each having a positive peak potential alternately to the row electrodes X and Y as shown in FIG. 23, repeatedly in the number of times corresponding to the intensity weight for the sub-field (even number of times). The X-electrode driver 51 places the row electrodes X₁-Xₙ in a floating state in the rise period of the sustain pulse IP to be applied to the row electrodes Y₁-Yₙ, and sets the row electrodes X₁-Xₙ at the ground potential (0 volt) in the following, remaining duration of sustain pulse IP application. The potential on each of the row electrodes X₁-Xₙ placed in a floating state rises following the potential rise on each of the row electrodes Y₁-Yₙ as shown in FIG. 16. When the potential on each of the electrodes Y₁-Yₙ is clamed by the potential Vs, the relevant potential gradually lowers and reaches the ground potential. Likewise, the Y-electrode driver 53 places the row electrodes Y₁-Yₙ in a floating state in the rise period of the sustain pulse IP to be applied to the row electrodes X₁-Xₙ, and sets the row electrodes Y₁-Yₙ at the ground potential in the following, remaining duration of sustain pulse IP application, as was shown in FIG. 15. The potential on each of the row electrodes Y₁-Yₙ placed in a floating state rises following the potential rise on each of the row electrodes X₁-Xₙ as shown in FIG. 15. When the potential on each of the electrodes X₁-Xₙ is clamed by the potential Vs, the relevant potential gradually lowers and reaches the ground potential.

In the sustain stage I of each of the sub-fields SF3-SF14, a sustain discharge is caused between the row electrodes X and Y in the discharge cell PC set in on-mode each time the sustain pulse IP is applied as shown in FIG. 23. On this occasion, by illuminating the light from the phosphor layer 17 to the outside through the front transparent substrate 10 due to the sustain discharge, light emission is effected for display in the number of times corresponding to the intensity weight for the relevant sub-field SF.

In the sustain stage I of each of the sub-fields SF3-SF14, wall charges are formed negative around the row electrode Y and positive around the row electrode X and column electrode D in the discharge cell PC where a sustain discharge was caused by the last sustain pulse IP. After the application of the last sustain pulse IP, the Y-electrode driver 53 applies a wall-charge adjusting pulse CP having a negative peak potential moderate in potential change at the leading edge with the passage of time as shown in FIG. 23, to the row electrodes Y₁-Yₙ. In response to the application of the wall-charge adjusting pulse CP, a weak erase discharge is caused in the discharge cell PC where a sustain discharge occurred as in the above, to erase part of the wall charges formed therein. This adjusts the wall charges of the discharge cell PC to an amount that can correctly cause a selective erase address discharge in the next selective erase address stage W_{D}.

In each of the first and second reset stages R1, R2 shown in FIG. 23, although reset discharge is caused simultaneously for all the discharge cells, reset discharge may be executed differently in time on a block-by-block basis wherein each block is formed by a plurality of pixel cells.

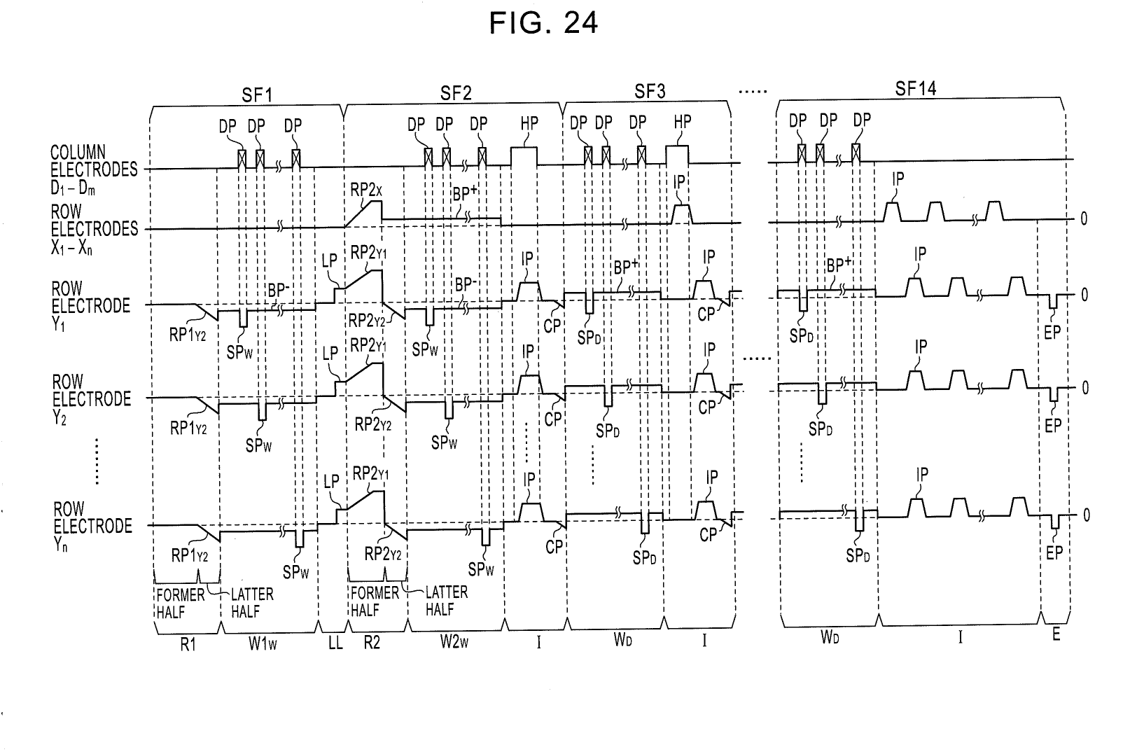

Furthermore, in the first reset stage R1 shown in FIG. 23, although a first reset discharge is caused as a cathode-at-column discharge by applying a reset pulse RP1_{Y1} to the row electrodes Y₁-Yₙ in the former half thereof, the row electrodes Y₁-Yₙ are fixed at the ground potential in the former half of the first reset stage R1 as shown in FIG. 24, for example.

In the embodiments in FIGS. 13, 23 and 24, any one or a combination of the following (1) to (10) can be utilized as modifications upon applying a sustain pulse.

(1) Instead of placing the row electrode Yj in a floating state in the duration of t1-t2 shown in FIG. 15, the relevant row electrode Yj may be grounded through an impedance having a predetermined value or greater. Here, a predetermined value or greater is such an impedance value that can raise the potential on the row electrode Yj to an extent that the voltage between the row electrodes Xj and Yj goes below the cell discharge start voltage through the resonant action of the sustain pulse generating circuit as to the row electrode Xj. Specifically in value, the above action can be obtained if using an element having a value of 10 kW or greater as a resistor or 1000 pF or greater as a capacitor. In such a case, operational effects are available similarly to the foregoing embodiments. This is true for the case where the row electrode Xj is placed in a floating state, as shown in FIG. 16.

(2) Instead of placing the row electrode Yj in a floating state in the duration of t1-t2 shown in FIG. 15, the row electrode Yj may be set at a rated potential “b” by connecting a rated power source positive in voltage to the row electrode Yj. In also this case, operational effects are available similarly to the foregoing embodiments. This is true for the case where the row electrode Xj is placed in a floating state, as shown in FIG. 16.

(3) In the case of applying a negative pulse as a sustain pulse, the foregoing t1 and t2 are set up as a period falling down to the negative rated potential Vs. In also this case, operational effects are available similarly to the foregoing embodiments. Incidentally, in the case that the sustain pulse is a negative pulse in the example that is connected to a rated power source in the period of t1-t2 as in the above (2), the rated power source for use is to output a negative voltage (rated potential “c”). This is true for the case that a negative sustain pulse is applied to the row electrode Yj as was shown in FIG. 16.

(4) In place of executing the floating state with a period on the row electrodes Xj, Yj, it may be applied only any one of the row electrodes.

(5) In place of executing a floating state upon applying every sustain pulse, it may be executed only upon applying a particular sustain pulse or applying a sustain pulse in a particular sub-field.

(6) The row electrode Yj may control the period of floating state depending upon the number of sustain pulses for emitting light within one field, i.e. upon light-emission load. At a great light-emission load, a great current flows simultaneously to distort the waveform of the sustain pulse. Waveform distortion results in the lowered intensity level. For this reason, because the duration of floating state if increased causes a larger overshoot that increases the overshoot potential, an intensity level independent of light-emission load can be obtained by providing uniform the effective voltage for discharge without resorting to light-emission load through properly regulating the start and termination timing of the floating state duration. Here, for regulating the start and termination timing of a floating state period, there are methods of adjusting the turn-off time of the switch element S14 between the turning-on time of the switch element S1 and the turning-on time of the switch element S3, of adjusting the turn-on time of the switch element S14 between the turning-on time of the switch element S3 and the turning-off time thereof, and of making a temporal adjustment by synchronizing the turn-on time of the switch element S14 with the turn-on time of the switch element S3, for example. The structure may be provided such that, where light-emission load is smaller than a predetermined value, the existing drive scheme may be applied that a floating state period is not provided wherein no floating state is given by keeping the switch element S14 on in the duration of t1-t2 whereas, where equal to or greater than the predetermined value, a floating state may be provided to implement the structure like the foregoing embodiment. This is true for such a case where the row electrode Xj is placed in a floating state as shown in FIG. 16.

(7) The start and termination timing of the floating state duration, in the foregoing (6), may be regulated independently on each of sub-fields or sustain pulses.

(8) The start and termination timing of the floating state duration, in the foregoing (6), may be regulated depending upon the cumulative drive time to the PDP 50. There are possible cases that discharge characteristics vary between the discharge cells to change the discharge start voltage depending upon the cumulative drive time to the PDP 50. Because the relationship between a period of floating state and an amount of overshoot is as per the foregoing, an intensity level independent of the panel cumulative drive time can be obtained by providing uniform the effective voltage for discharge without resorting to panel cumulative drive time through properly regulating the start and termination timing of the floating state duration. In this case, for a certain cumulative drive time, the existing drive scheme may be applied that a floating state period is not provided by keeping the switch element S14 on in the duration of t1-t2. This is true for the case where the row electrode Xj is placed in a floating state, as shown in FIG. 16.

(9) Under the condition of the foregoing (6), (7) and (8), the turn-on timing of the switch element S14 may be given independent of the turn-on/off timing of the other switch elements. In this case, the turn-on timing of the switch element S14 is not earlier in time than the turn-on timing of the switch element S1 at time t1. Meanwhile, as described in the foregoing (6), the switch elements S14 and S3 may be changed in turn-on timing with synchronization under each of the conditions. This is true for the case where the row electrode Xj is placed in a floating state, as shown in FIG. 16.

(10) The foregoing embodiments explained the example of the PDP containing CL-emission MgO crystals in the protection layer and phosphor layer, which however is not limitative. Operational effects are available similarly even on a PDP not containing CL-emission MgO crystals. Nevertheless, because the PDP containing CL-emission MgO crystals is less in the delay of discharge and easy to cause a sustain discharge in the rise course of the sustain pulse, the problem is more conspicuous that was explained in the introductory part. Therefore, the use of a PDP containing CL-emission MgO crystals can provide the operational effect of the invention conspicuously furthermore.

This application is based on Japanese Patent Applications No. 2007-057185 and No. 2007-124630 which are hereby incorporated by reference.

What is claimed is:

1. A method for driving a plasma display panel based on gradation levels of a plurality of sub-fields for each unit display period of an input video signal, wherein the plasma display panel has front and back substrates oppositely arranged sandwiching a discharge space filled with discharge gas, a plurality of pairs of row electrodes arranged between the front substrate and the back substrate, and a plurality of column electrodes arranged intersecting with the row electrode pairs, so as to respectively form discharge cells each having a phosphor layer at intersections of the row electrode pairs and the column electrodes, the method comprising:
executing, in each of the sub-fields, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pair;
wherein, in the sustain stage, an auxiliary pulse for maintaining a pulse peak potential is applied to the row electrodes during at least part of a leading-edge period of the sustain pulse.

2. The method according to claim 1, wherein, in the sustain stage, the auxiliary pulse is applied to the row electrodes during a period from a time point before a time point reaching a peak potential of the sustain pulse at a leading edge thereof to the time point reaching the peak potential of the sustain pulse.

3. The method according to claim 1, wherein the application of the auxiliary pulse is started at a time point earlier by a predetermined marginal period than a start time point of the leading edge.

4. The method according to claim 1, wherein the application of the auxiliary pulse is started at a time point later than a start time point of the leading edge.

5. The method according to claim 1, wherein the auxiliary pulse is applied during a period including the leading edge and a peak potential of the sustain pulse.

6. The method according to claim 1, wherein the sustain pulse is a pulse first applied in the sustain stage.

7. The method according to claim 1, wherein the sustain pulse is applied only in the sustain stage of a sub-field to which a value of an intensity weight smaller than a predetermined value in the sustain stage is assigned, of the sub-fields within the unit display period.

8. The method according to claim 1, wherein a reset stage for initializing the discharge cells into one of the on-mode and off-mode is executed immediately before the address stage, in one of the sub-fields within the unit display period, and
a voltage is applied between the one row electrodes and the column electrodes so that the one row electrodes become anodes and the column electrodes become cathodes in the reset stage so as to cause reset discharges between the one row electrodes and the column electrodes.

9. The method according to claim 8, wherein the one sub-field is a beginning sub-field of the unit display period, the reset stage being executed only in the one sub-field within the unit display period.

10. The method according to claim 8, wherein the one sub-field is a sub-field immediately succeeding a beginning sub-field within the unit display period,
the reset stage for initializing the discharge cells into one of the on-mode is executed in the beginning sub-field.

11. The method according to claim 10, wherein a voltage is applied between the one row electrodes and the column electrodes so that the one row electrodes become anodes and the column electrodes become cathodes in the reset stage.

12. The method according to claim 10, wherein the reset stage is executed only in the beginning sub-field and the one sub-field within the unit display period.

13. The method according to claim 10, wherein, immediately after the address stage of the beginning sub-field, a voltage is applied between the one row electrodes and the column electrodes so that the one row electrodes become anodes and the column electrodes become cathodes, to execute a slight-emission stage for causing slight-emission discharges between the column electrodes and the one row electrodes in each discharge cell set in the on mode in the address stage of the beginning sub-field.

14. The method according to claim 13, wherein each of the slight-emission discharges is a discharge with a light emission corresponding to a gradation of high luminance by one level higher than a luminance level 0

15. The method according to claim 1, wherein the phosphor layer contains a phosphor material and a secondary electron emission material.

16. The method according to claim 14, wherein the secondary electron emission material is formed of magnesium oxide.

17. The method according to claim 16, wherein the magnesium oxide contains a magnesium oxide crystallization which is excited on an electronic beam to cause a cathode-luminescence emission having a peak at a wavelength of 200-300 nm.

18. The method according to claim 17, wherein the magnesium oxide crystallization is produced by vapor phase oxidation.

19. The method according to claim 15, wherein grains of the secondary electron emission material are in contact with the discharge gas in the discharge space.

20. The method according to claim 1, wherein the sustain pulse and the auxiliary pulse have peak potentials identical in polarity to each other.

21. A method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising:
executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs;
wherein, in the sustain stage, the other row electrodes are placed in a floating state during at least part of a period from a time point of a leading edge before reaching a peak potential of the sustain pulse, on the one row electrodes, to a time point reaching the peak potential, and then set equal to a ground potential following the floating state.

22. The method according to claim 21, wherein the other row electrodes are placed in the floating state during a period from a time point that the application of the sustain pulse is started to a time point that the sustain pulse reaches the peak potential, and grounded after the period of the floating state.

23. The method according to claim 21, wherein the one row electrodes are placed in the floating state during at least part of a period from the time point of the leading edge before reaching the peak potential of the sustain pulse on the other row electrodes to the time point reaching the peak potential, and then set equal to the ground potential.

24. The method according to claim 21, wherein the floating state and the following ground-potential state are executed every time the sustain pulse is applied within one field.

25. The method according to claim 21, wherein the floating state and the following ground-potential state are executed when applying a particular sustain pulse.

26. The method according to claim 22, wherein the start time point of grounding after the duration of the floating state is same as a time point that the sustain pulse reaches the peak potential.

27. The method according to claim 22, wherein the start time point of the floating state and/or the start time point of grounding are adjusted in accordance with a light-emission load within one field.

28. The method according to claim 22, wherein the start time point of the floating state and/or the start time point of grounding are adjusted for each of the sub-fields.

29. The method according to claim 22, wherein the start time point of the floating state and/or the time point of grounding are adjusted in accordance with a cumulative drive time of the plasma display panel.

30. The method according to claim 27, wherein the time point that the sustain pulse reaches the peak potential is adjusted in accordance with a light-emission load within one field.

31. The method according to claim 28, wherein the time point that the sustain pulse reaches the peak potential is adjusted for each of the sub-fields.

32. The method according to claim 29, wherein the time point that the sustain pulse reaches the peak potential is adjusted in accordance with a cumulative drive time of the plasma display panel.

33. The method according to claim 21, wherein
in one of the plurality of sub-fields, a reset stage is executed to initialize the discharge cells being in one of the on-mode and off-mode immediately before the address stage, and
in the reset stage, a voltage is applied between the one row electrodes and the column electrodes so that the one row electrodes become anodes and the column electrodes become cathodes in the reset stage.

34. The method according to claim 33, wherein the one sub-field is a beginning sub-field of the one field, the reset stage being executed only in the one sub-field.

35. The method according to claim 33, wherein the reset stage is executed to initialize the discharge cells being in one of the on-mode and off-mode immediately before the address stage, in a beginning sub-field in the one sub-field provided immediately before the one sub-field.

36. The method according to claim 35, wherein a voltage is applied between the one row electrodes and the column electrodes so that the one row electrodes become anodes and the column electrodes become cathodes in the reset stage, in the reset stage of the beginning sub-field.

37. The method according to claim 35, wherein the reset stage is executed only in the beginning sub-field and the one sub-field within the one field.

38. The method according to claim 35, wherein a slight emission phase is executed to cause slight emission discharges between the column electrodes and the one row electrodes in the discharge cells set in the on-mode in the address stage of the beginning sub-field by applying a voltage between the one row electrodes and the column electrodes so that the one row electrodes become anodes and the column electrodes become cathodes, immediately after the address stage of the beginning sub-field.

39. The method according to claim 38, wherein each of the slight emission discharges is a discharge with a light emission corresponding to a gradation of high luminance by one level higher than a luminance level 0.

40. The method according to claim 21, wherein the phosphor layer contains a phosphor material and a secondary-electron emission material.

41. The method according to claim 40, wherein the secondary-electron emission material consists of magnesium oxide.

42. The method according to claim 41, wherein the magnesium oxide contains a magnesium oxide crystallization which is excited on an electronic beam to cause a cathode-luminescence emission having a peak at a wavelength of 200-300 nm.

43. The method according to claim 42, wherein the magnesium oxide crystallization is produced by vapor phase oxidation.

44. The method according to claim 40, wherein grains of the secondary-electron emission material are in contact with the discharge gas in the discharge space.

45. The method according to claim 42, wherein the magnesium oxide crystallization has a grain size of 2000 angstroms or greater.

46. A method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising:
executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs;
wherein, in the sustain stage, each of the other row electrodes is set equal to a ground potential through an element having an impedance of a predetermined value or greater during at least part of a period from a time point of a leading edge before reaching a peak potential of the sustain pulse, on the one row electrodes, to a time point reaching the peak potential, and then directly set equal to the ground potential.

47. The method according to claim 46, wherein the element is a resistor having 10 kW or greater or a capacitor having 1000 pF or greater.

48. A method for driving a plasma display panel to perform a gradation display in accordance with an input video signal, wherein the plasma display panel has front and back substrates oppositely arranged sandwiching a discharge space filled with discharge gas, a plurality of pairs of row electrodes arranged between the front substrate and the back substrate, a plurality of column electrodes arranged intersecting with the row electrode pairs, so as to respectively form discharge cells each having a phosphor layer at intersections of the row electrode pairs and the column electrodes, the method comprising:
executing, in each of a plurality of sub-fields into which a one-field display period is divided, an address stage for setting each of the discharge cells in one of on-mode and off-mode selectively in the discharge cells in accordance with pixel data corresponding to the input video signal, and a sustain stage for applying a sustain pulse alternately to ones and others of the row electrodes in the pairs;
wherein, in the sustain stage, each of the other row electrodes is applied with a positive or negative potential during at least part of a period from a time point of a leading edge before reaching a peak potential of the sustain pulse, on the one row electrodes, to a time point reaching the peak potential, and then directly set equal to the ground potential.

49. The method according to claim 48, wherein the positive potential is applied to the each of the other row electrodes in the case that the peak potential is positive and the negative potential is applied to each of the other row electrodes in the case that the peak potential is negative.
